(19) United States
(12) Patent Application Publication
(10) Pub. No.: US 2009/0131589 A1
(43) Pub. Date: May 21, 2009

(54) CONTROLLED MOLECULAR WEIGHT AMINO ACID POLYMERS HAVING FUNCTIONALIZABLE BACKBONES AND END GROUPS AND PROCESSES FOR PREPARING THE SAME

(76) Inventors: Carmen Scholz, Madison, AL (US); Willy Vayaboury, Huntsville, AL (US)

Correspondence Address: Ballard Spahr Andrews & Ingersoll, LLP, SUITE 1000, 999 PEACHTREE STREET, ATLANTA, GA, 30309-3915, US

(21) Appl. No.: 12/260,440

(22) Filed: Oct. 29, 2008

Related U.S. Application Data
(60) Provisional application No. 60/984,110, filed on Oct. 31, 2007.
(60) Provisional application No. 61/036,313, filed on Mar. 13, 2008.

(51) Int. Cl. C08G 69/10; C08G 69/04

(52) U.S. Cl. 525/54.11; 528/328; 525/54.1

(57) ABSTRACT

The present disclosure relates to processes for preparing metal-free, mono-dispersed polymers of amino acids. The polymers include homopolymers, random copolypeptides, block copolypeptides, block copolymers with at least one peptidyl block, grafted copolypeptides, and polypetidyl dendrimers. The disclosed process does not make use of a heavy metal catalyst, inter alia, copper or nickel containing reagents. The disclosed process encompasses a “living polymerization” such that the growth of each polymer chain is not truncated or otherwise halted by undesirable side reactions or limitations due to the length or size of the growing polymer chain, provides amino acid comprising polymers having a narrow polydispersity, is conducted at lower temperatures, and avoids the premature secondary folding that inhibits the formation of polymers having a low polydispersity index. This abstract is intended to provide key words and search terms for use in searching patent and patent application data bases and is not intended to limit the subject matter of the disclosure.

### CROSS-REFERENCE TO RELATED APPLICATIONS

This application claims benefit of priority to U.S. Provisional Application Ser. No. 60/984,110 filed Oct. 31, 2007 and U.S. Provisional Application Ser. No. 61/036,313 file Mar. 13, 2008, both of which are herein incorporated by reference in their entirety.

### STATEMENT REGARDING FEDERALLY FUNDED RESEARCH

Portions of the research and inventions disclosed herein may have been made with U.S. Government support under the National Institutes of Health Grant No. 1 RO1 EY016674-01 and Veterans Administration (Boston) Grant No. V523P-6826. The U.S. government may have certain rights in this invention.

### FIELD

The present disclosure relates to amino acid containing polymers having a controlled molecular weight wherein the polymers do not contain residual metal catalytic material. The disclosed polymers have backbone units and side chain end groups that can be separately functionalized with one or more groups chosen by the formulator. The present disclosure further relates to processes for preparing metal-free, mono-disperse polymers of amino acids. The polymers include homopolymers, random copolypeptides, block copolypeptides, block copolymers with at least one peptidyl block, grafted copolypeptides, and polypetidyl dendrimers.

### BACKGROUND

Synthetic polypeptides have a number of advantages over peptides produced in biological systems and have been used to make fundamental contributions to both the physical chemistry of macromolecules and the analysis of protein structures (Fasman, G. D., “Poly .alpha.-Amino Acids,” Dekker, N.Y., (1967)). Moreover, synthetic peptides are both more cost efficient and can possess a greater range of material properties than peptides produced in biological systems.

Small synthetic peptide sequences, typically less than 100 residues in length, are conventionally prepared using stepwise solid-phase synthesis such as the procedure by R. B. Merrifield for use in the preparation of certain peptides. Such solid phase synthesis makes use of an insoluble resin support for a growing oligomer. However, a major disadvantage of conventional solid phase synthetic methods for the preparation of oligomeric materials results from the fact that the reactions involved in the scheme are imperfect; no reaction proceeds to 100% completion. As each new subunit is added to the growing oligomeric chain a small, but measurable, proportion of the desired reaction fails to take place. The result of this is a series of peptides or other oligomers having deletions in their sequence. The result of the foregoing imperfection in the synthetic scheme is that as desired chain length increases, the effective yield of desired product decreases drastically, since increased chances for deletion occur. Similar considerations attend other types of unwanted reactions, such as those resulting from imperfect blocking, side reactions, and the like. Of equal, if not greater, significance, is the fact that the increasing numbers of undesired polymeric species which result from the failed individual reactions produce grave difficulties in purification. For example, if a polypeptide is desired having 100 amino acid residues, there may be as many as 99 separate peptides having one deleted amino acid residue and an even greater possible number of undesired polymers having two or more deleted residues, side reaction products and the like.

The chemical synthesis of high molecular weight polypeptides is most directly accomplished by the ring-opening polymerization of α-amino acid-N-carboxyanhydride (NCA) monomers (Kricheldorf, H. R., “Models of Biopolymers by Ring-Opening Polymerization,” Penczek, S. Ed., CRC Press, Boca Raton, (1990)). N-carboxyanhydride polymerizations, however, suffer from several disadvantages. Side reactions can occur because as the peptide begins to grow, protein folding into the secondary structure begins to occur. As such, there tends to be a growing number of different species (polymers having a wide range of molecular weights) undergoing reaction. This results in polymers having very broad molecular weight distributions; M_{w}/Mₙ values from about 4 to about 10 (Lundberg R. D., et al., J. Am. Chem. Soc., 79:3961-3972 (1957)).

However, the previously disclosed methods for peptidyl synthesis using the ring-opening polymerization of α-amino acid-N-carboxyanhydride monomers (U.S. Pat. No. 6,686,446) utilizes catalysts that contain heavy metal ions, inter alia, copper and nickel. Removal of these heavy metals is both time consuming and incomplete. Therefore, the use of amino acid containing polymers made by these methods in vivo must be approached with caution. In addition, scale up of these metal containing reactions can be problematic for various reasons, for example, the need to dispose of large quantities of heavy metal-containing waste.

There is therefore a need for a process of preparing polymers of amino acids wherein the growing amino acid chain is prevented from undergoing folding into its natural secondary structure. There is also a need for a process for forming amino acid comprising polymers that does not involve the use of heavy metals.

### SUMMARY

The present disclosure relates to homopolymers, random copolymers, and block copolymers of amino acids, protected amino acids, and mixtures thereof wherein the polymers do not comprise any residual heavy metal catalyst.

The present disclosure further relates to a process for preparing polymers comprising amino acids without the use of a heavy metal catalyst, inter alia, copper or nickel containing reagents. The disclosed process encompasses a “living polymerization” such that the growth of each polymer chain is not truncated or otherwise halted by undesirable side reactions or limitations due to the length or size of the growing polymer chain. In addition, the disclosed process provides amino acid comprising polymers having a narrow polydispersity. Further the disclosed process is conducted at lower temperatures and avoids the premature secondary folding that inhibits the formation of polymers having a low polydispersity index.

### BRIEF DESCRIPTION OF THE FIGURES

FIG. 1 depicts a comparison between the polydispersity of (polyethylene glycol MW 5000)-b-poly(TFA-L-lysine)₁₀₀ prepared without a hydrogen bond inhibitor at room temperature and (polyethylene glycol MW 5000)-b-poly(TFA-L-lysine) prepared using a hydrogen bond inhibitor at 0° C. disclosed process. The dashed line shows the polydispersity of a sample prepared according to Example 1 and the solid line shows the polydispersity of a sample prepared using the disclosed process as depicted in Example 2.

FIG. 2 depicts the bimodal character of CH₃(CH₂)₅NH[Lys]₁₀ polymer formed using prior art at room temperature.

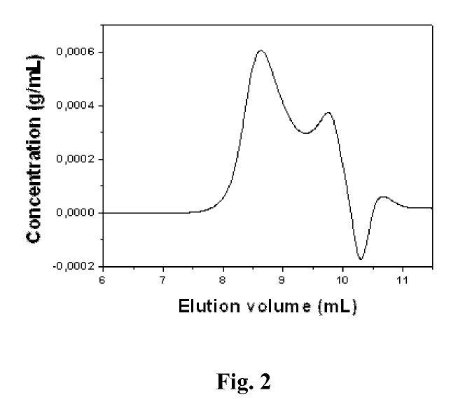

FIG. 3 depicts the low polydispersity character of a disclosed CH₃(CH₂)₅NH[Lys]₁₀ polymer prepared at 0° C. in the presence of the inhibitor thiourea.

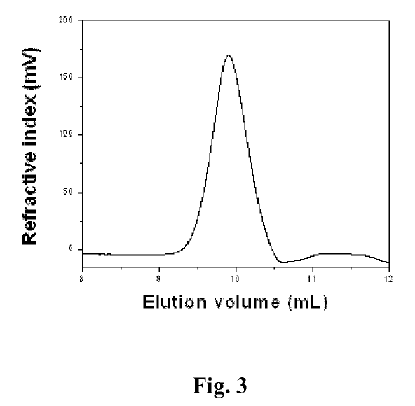

FIG. 4 depicts a comparison between PEGNH₂ (having an average molecular weight of about 5,000 Da) starting material, and PEGNH(5,000)-[Lys]₁₀ polymer, and PEGNH(5,000)-[Lys]₅₀ polymer according to the present disclosure.

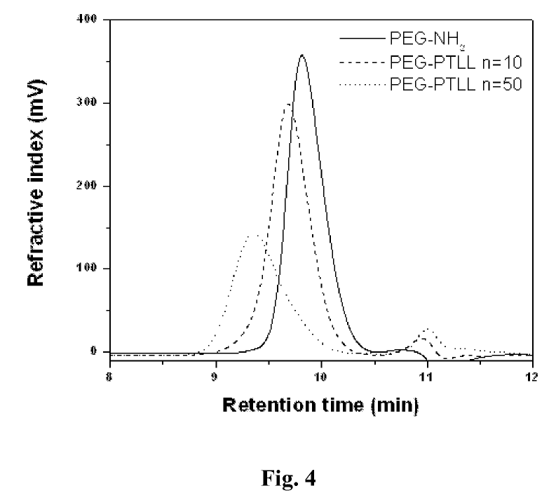

### DETAILED DESCRIPTION

In this specification and in the claims that follow, reference will be made to a number of terms, which shall be defined to have the following meanings:

By “pharmaceutically acceptable” is meant a material that is not biologically or otherwise undesirable, i.e., the material can be administered to an individual along with the relevant active compound without causing clinically unacceptable biological effects or interacting in a deleterious manner with any of the other components of the pharmaceutical composition in which it is contained.

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “the compound” includes mixtures of two or more such compounds, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed, then “less than or equal to” the value, “greater than or equal to the value,” and possible ranges between values are also disclosed, as appropriately understood by the skilled artisan. For example, if the value “10” is disclosed, then “less than or equal to 10” as well as “greater than or equal to 10” is also disclosed. It is also understood that throughout the application data are provided in a number of different formats and that this data represent endpoints and starting points and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

An organic radical can have, for example, 1-26 carbon atoms, 1-18 carbon atoms, 1-12 carbon atoms, 1-8 carbon atoms, or 1-4 carbon atoms. Organic radicals often have hydrogen bound to at least some of the carbon atoms of the organic radical. One example, of an organic radical that comprises no inorganic atoms is a 5,6,7,8-tetrahydro-2-naphthyl radical. In some embodiments, an organic radical can contain 1-10 inorganic heteroatoms bound thereto or therein, including halogens, oxygen, sulfur, nitrogen, phosphorus, and the like. Examples of organic radicals include but are not limited to an alkyl, substituted alkyl, cycloalkyl, substituted cycloalkyl, mono-substituted amino, di-substituted amino, acyloxy, cyano, carboxy, carboalkoxy, alkylcarboxamido, substituted alkylcarboxamido, dialkylcarboxamido, substituted dialkylcarboxamido, alkylsulfonyl, alkylsulfinyl, thioalkyl, thiohaloalkyl, alkoxy, substituted alkoxy, haloalkyl, haloalkoxy, aryl, substituted aryl, heteroaryl, heterocyclic, or substituted heterocyclic radicals, wherein the terms are defined elsewhere herein. A few non-limiting examples of organic radicals that include heteroatoms include alkoxy radicals, trifluoromethoxy radicals, acetoxy radicals, dimethylamino radicals and the like.

The term “number average molecular weight” (Mₙ) is defined herein as the mass of all polymer molecules divided by the number of polymer molecules which are present.

The term “weight average molecular weight” (M_{w}) is defined herein as the mass of a sample of a polymer divided by the total number of molecules that are present.

The term “polydispersity” is defined herein as the weight average molecular weight, M_{w}, divided by the number average molecular weight, Mₙ.

The term “amino acid block copolymer” as used herein refers to poly(amino acids) comprised of sequences containing domains (“blocks”) of at least two continuous residues of a single type of amino acid covalently linked to at least two continuous residues of a distinct single type of amino acid by a convention polyamide linkage found in polypeptides. The number, length, order, and composition of these sequences can vary to include all possible amino acids in any number of repeats. In one embodiment the total number of overall monomer units (residues) in the amino acid block copolymer is greater than 100 and the distribution of chain-lengths in the amino acid block copolymer is about 1.01<M_{w}/Mₙ<1.5, wherein M_{w}/Mₙ is the weight average molecular weight divide by the number average molecular weight as defined herein.

The terms “protection” and “side-chain protecting group” as used herein refer to chemical substituents placed on reactive functional groups, typically nucleophiles or sources of protons, to render them unreactive as protic sources or nucleophiles. The choice and placement of these substituents was according to literature procedures. M. Bodanszky, et al., The practice of Peptide Synthesis, 2nd Ed., Springer, Berlin/Heidelberg, (1994). Non-limiting examples of protecting groups are further described herein.

Heavy metals used in the prior art for the preparation of amino acid comprising polymers cannot be adequately removed. This causes the polymers to not be fully biocompatible. In addition, the formulator utilizing these procedures must take special care to dispose of metal waste in a proper manner.

The disclosed polymers provide substrates that can be used to deliver a physiologically active ingredient to a living species. In addition, the disclosed polymers can be used for analysis of biological systems in vivo, ex vivo, and in vitro. The disclosed polymers are prepared by a process that does not comprise the use of standard metal catalysts, and as such, provides several unmet needs, including:
A) Full control over polymer molecular weight;
B) Full control over molecular weight distribution;
C) Control over the molecular architecture of the polymer;
D) Absence of heavy metal contaminants;
E) Providing backbone that can comprise a multitude of different functional units achievable by selective protection de-protection of the backbone units; and
F) Affording polymers comprising side chains, grafting, and terminal groups as a means for further functionalizing the disclosed polymers.

The low polydispersity of the disclosed polymers allows for accurate stoichiometric modification of both the backbones and provides a means for selectively functionalizing the backbones by adjusting the stoichiometry of the modifying reagent. For example, by using 0.5 equivalents of a side chain modifying group, the formulator can modify 50% of the chosen side chains. Because of the low polydispersity, selective modification can be achieved.

### Polymers

Disclosed herein are ultra pure polymers having the formula:

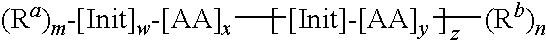

wherein AA represents one or more protected or unprotected amino acid residues; Init is a polymerization initiator residue; R^{a} and R^{b} are polymer chain end groups, R^{a} is present when the index m is equal to 1 and R^{a} is absent when the index m is equal to 0, R^{b} is present when the index n is equal to 1 and R^{b} is absent when the index n is equal to 0; the index w is 0 or 1; the index x is from about 10 to about 400; the index y is from about 10 to about 400; and the index z is from 0 to 5.

The disclosed polymers include amino acid homopolymers, random copolypeptides, block copolypeptides, block copolymers with at least one peptidyl block, grafted copolypeptides, and polypetidyl dendrimers.

The disclosed polymers can comprise in one embodiment from about 10 to about 400 amino acid residues. In another embodiment, the polymers can comprise from about 100 to about 200 amino acid residues. In a further embodiment, the polymers can comprise from about 10 to about 150 amino acid residues. In one iteration of this embodiment, the polymers can comprise from about 10 to about 150 amino acid residues together with a PEG or MPEG block having an aver age molecular weight of from about 500 g/mol to about 20,000 g/mol. However, other embodiments and combination are possible and are not meant to be limited herein.

The disclosed polymers have a polydispersity of greater than 1 to about 1.5. In one embodiment, the polydispersity is from greater than 1 to less than about 1.5. In another embodiment, the polydispersity is from about 1.01 to about 1.5, while in a further embodiment, the polydispersity is from about 1.01 to about 1.3. A still further embodiment relates to polydispersity from about 1.1 to about 1.3.

The disclosed polymers can have a molecular weight of from about 500 Daltons to about 150,000 Daltons. In another embodiment, the disclosed polymers can have a molecular weight of from about 3,000 Daltons to about 20,000 Daltons. In a further embodiment, the disclosed polymers can have a molecular weight of from about 5,000 Daltons to about 10,000 Daltons. In yet another embodiment, the disclosed polymers can have a molecular weight of from about 15,000 Daltons to about 40,000 Daltons. In as still further embodiment, the disclosed polymers can have a molecular weight of from about 1,000 Daltons to about 10,000 Daltons. In as yet still further embodiment, the disclosed polymers can have a molecular weight of from about 10,000 Daltons to about 25,000 Daltons.

### AA Units

AA represents homopolymers, random copolymers, or block copolymers of one or more protected or unprotected amino acids. The random copolymers can be combinations of unprotected and protected amino acids. The block copolymers can be blocks of two or more protected amino acids, blocks of two or more unprotected amino acids, or combinations of blocks comprising protected and unprotected amino acids.

Non-limiting examples of amino acids include alanine, γ-aminobutyric acid, 2-aminohexanoic acid, arginine, asparagine, aspartic acid, cysteine, glutamic acid, glutamine, glycine, homoserine, histidine, isoleucine, leucine, lysine, methionine, phenylalanine, phenylgylcine, proline, serine, threonine, tryptophan, tyrosine, and valine. However, any amino acid can be used to form the AA polymers disclosed herein. Protected amino acids are amino acids having a chemically reactive side chain that is protect in order to insure the side chain does not participate in a chemical reaction until the side chain protecting group is removed. The following are non-limiting examples of amino acids that can be protected by one or more different types of protecting groups: arginine, asparagine, aspartic acid, cysteine, glutamic acid, glutamine, homoserine, histidine, lysine, serine, threonine, tryptophan, and tyrosine.

### Protecting Groups

The amino acids suitable for use in the disclosed processes can have one or more protecting groups. The protecting groups can be used to protect side group functional moieties, for example, aspartic acid and glutamic acid can be protected with methyl thereby forming esters, for example, the aspartic acid benzyl ester having the formula:

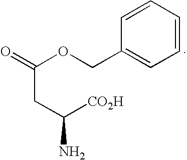

Likewise, amino groups can be protected, for example, trifluoroacetate protected amines such as N-trifluoroacetate lysine having the formula:

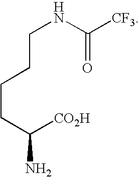

Non-limiting examples of protecting groups are chosen from methyl, formyl, ethyl, acetyl, tert-butyl, anisyl, benzyl, trifluoroacetyl, N-hydroxysuccinimide, tert-butoxycarbonyl, methoxycarbonyl, benzoyl-4-methylbenzyl, thioanizyl, thiocresyl, benzyloxymethyl, 4-nitrophenyl, benzyloxycarbonyl, 2-nitrobenzoyl, 2-nitrophenylsulphenyl, 4-toluenesulphonyl, pentafluorophenyl, diphenylmethyl, 2-chlorobenzyloxycarbonyl, 9-fluorenylmethyloxycarbonyl, triphenylmethyl, and 2,2,5,7,8-pentamethyl-chroman-6-sulphonyl.

One category of AA units relates to homopolymers of protected or unprotected amino acids. A first embodiment of AA units relates to homopolymers of unprotected amino acids. One iteration of this embodiment relates to AA homopolymers of amino acids chosen from:

i) lysine;

ii) ornithine;

iii) aspartic acid;

iii) glutamic acid;

iv) cysteine;

v) arginine;

vi) serine; or

vii) threonine.

Non-limiting examples of this iteration include the following homopolymers:

i) homopolymers of lysine:

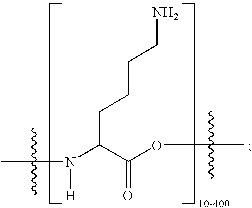

ii) homopolymers of ornithine:

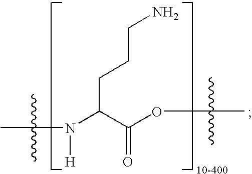

iii) homopolymers of aspartic acid:

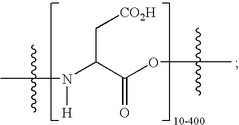

iv) homopolymers of glutamic acid:

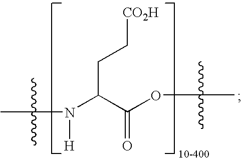

v) homopolymers of cysteine:

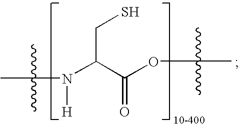

vi) homopolymers of arginine:

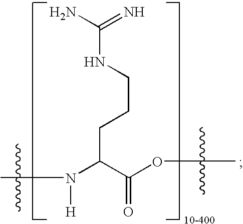

vii) homopolymers of serine:

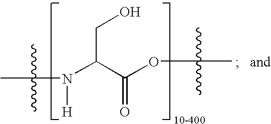

viii) homopolymers of threonine:

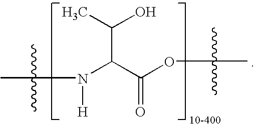

Another embodiment relates to AA homopolymers of protected amino acids chosen from:

j) lysine;

ii) ornithine;

iii) aspartic acid;

viii) glutamic acid;

ix) cysteine;

x) arginine;

xi) serine; or

xii) threonine.

Non-limiting examples of this iteration include the following homopolymers wherein P represents any removable protecting group:

i) homopolymers of protected lysine:

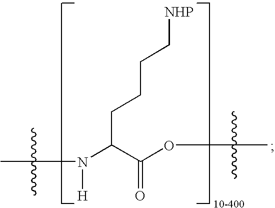

ii) homopolymers of protected ornithine:

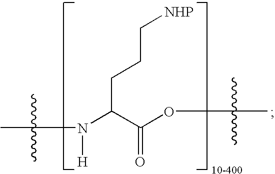

iii) homopolymers of protected aspartic acid:

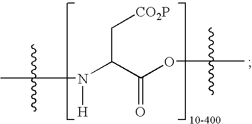

iv) homopolymers of protected glutamic acid:

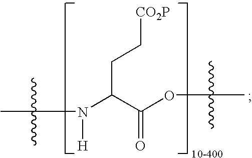

v) homopolymers of protected cysteine:

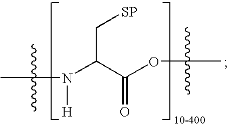

vi) homopolymers of protected arginine:

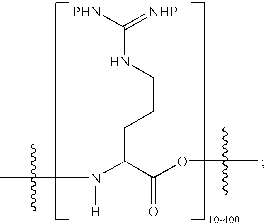

vii) homopolymers of protected serine:

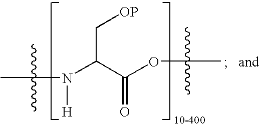

viii) homopolymers of protected threonine:

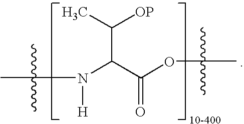

A further embodiment relates to AA homopolymers of protected amino acids wherein the protected amino acids comprise two or more different protecting groups that can be removed by different methods wherein removing one protecting group does not remove any other type of protecting groups that are present. A non-limiting example of this iteration includes a homopolymer of lysine having the formula:

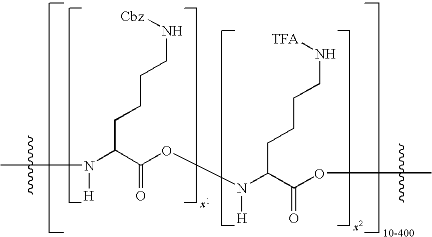

wherein a first protected lysine having a Cbz protecting group comprises x¹ mole percent of the homopolymer and a second protected lysine having a trifluoroacetate (TFA) protecting group comprises x² mole percent of the homopolymer. The sum of x¹+x²=from about 10 to about 400 total amino acid residues.

One example of this iteration includes AA units wherein from about 10% to about 99% of the protected amino acids comprise a first protecting group and the balance have a second protecting group that is capable of being removed without removing the first protecting group.

Another example of this iteration includes AA units wherein from about 10% to about 90% of the protected amino acids comprise a first protecting group and the balance have a second protecting group that is capable of being removed without removing the first protecting group.

A further example of this iteration includes AA units wherein from about 10% to about 70% of the protected amino acids comprise a first protecting group and the balance have a second protecting group that is capable of being removed without removing the first protecting group.

A still further example of this iteration includes AA units wherein from about 10% to about 50% of the protected amino acids comprise a first protecting group and the balance have a second protecting group that is capable of being removed without removing the first protecting group.

A yet further example of this iteration includes AA units wherein from about 10% to about 30% of the protected amino acids comprise a first protecting group and the balance have a second protecting group that is capable of being removed without removing the first protecting group.

### Init Units

Init units are derived from polymerization initiators that are used to initiate the synthesis of the disclosed polymers as further described herein. The term “derived from” is used throughout the specification in connection with the Init units that comprise the disclosed polymers. For example, as depicted in the following non-limiting Scheme I:

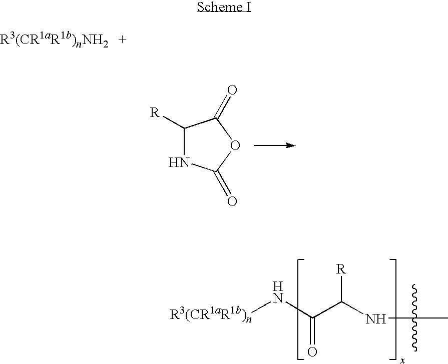

an amine having the formula:

R³(CR^{1a}R^{1b})ₙNH₂

can react with a generic amino acid precursor, in this case an N-carboxyanhydride, to initiate polymerization of the disclosed polymers. As used herein, the unit

R³(CR^{1a}R^{1b})ₙNH—

that comprises the depicted generic polymer is the Init unit and this unit therefore derives from an amine having the formula:

R³(CR^{1a}R^{1b})ₙNH₂.

The following are non-limiting examples of Init units:

i) homogeneous backbone alkoxy units having the formula:

R³[(CR^{1a}R^{1b})ₙ]ₘO—;

which can derive from alkyl alcohols having the formula:

R³[(CR^{1a}R^{1b})ₙ]ₘOH;

ii) homogeneous backbone polyalkylene glycol units having the formula:

H[O(CR^{1a}R^{1b})ₙ]ₘO— or —[O(CR^{1a}R^{1b})ₙ]ₘO—

which can derive from polyalkylene glycols having the formula:

H[O(CR^{1a}R^{1b})ₙ]ₘOH;

iii) heterogeneous backbone polyalkylene glycol units having the formula:

H[O(CR^{1a}R^{1b})ₙ]ₘ[O(CR^{2a}R^{2b})ⱼ]ₖO— or —[O(CR^{1a}R^{1b})ₙ]ₘ[O(CR^{2a}R^{2b})ⱼ]ₖO—

which can derive from polyalkylene glycols having the formula:

H[O(CR^{1a}R^{1b})ₙ]ₘ[O(CR^{2a}R^{2b})ⱼ]ₖOH;

iv) homogeneous backbone polyalkylene glycol units having the formula:

R³[O(CR^{1a}R^{1b})ₙ]ₘOH;

which can derive from polyalkylene glycols having the formula:

R³[O(CR^{1a}R^{1b})ₙ]ₘOH;

v) heterogeneous backbone alkoxy polyalkylene glycol units having the formula:

R³[O(CR^{1a}R^{1b})ₙ]ₘ[O(CR^{2a}R^{2b})ⱼ]ₖO—

which can derive from alkoxy polyalkylene glycols having the formula:

R³[O(CR^{1a}R^{1b})ₙ]ₘ[O(CR^{2a}R^{2b})ⱼ]ₖOH;

vi) homogeneous backbone alkylamino units having the formula:

R³[(CR^{1a}R^{1b})ₙ]ₘNH—;

which can derive from alkyl amines having the formula:

R³[(CR^{1a}R^{1b})ₙ]ₘNH₂;

vii) homogeneous backbone polyalkylene glycol amine units having the formula:

H[O(CR^{1a}R^{1b})ₙ]ₘNH— or —[O(CR^{1a}R^{1b})ₙ]ₘNH—

which can derive from polyalkylene glycol amines having the formula:

H[O(CR^{1a}R^{1b})ₙ]ₘNH₂;

viii) heterogeneous backbone polyalkylene glycol amine units having the formula:

H[O(CR^{1a}R^{1b})ₙ]ₘ[O(CR^{2a}R^{2b})ⱼ]ₖNH— or —[O(CR^{1a}R^{1b})ₙ]ₘ[O(CR^{2a}R^{2b})ⱼ]ₖNH—;

which can derive from polyalkylene glycol amines having the formula:

H[O(CR^{1a}R^{1b})ₙ]ₘ[O(CR^{2a}R^{2b})ⱼ]ₖNH₂;

ix) homogeneous backbone alkoxy polyalkylene glycol amine units having the formula:

R³[O(CR^{1a}R^{1b})ₙ]ₘNH—;

which can derive from alkoxy polyalkylene glycol amines having the formula:

R³[O(CR^{1a}R^{1b})ₙ]ₘNH₂;

x) homogeneous backbone alkoxy polyalkylene glycol diamine units having the formula:

—HNCR^{1a}R^{1b}[O(CR^{1a}R^{1b})ₙ]ₘNH₂ or —HNCR^{1a}R^{1b}[O(CR^{1a}R^{1b})ₙ]ₘNH—;

which can derive from alkoxy polyalkylene glycol diamines having the formula:

H₂NCR^{1a}R^{1b}[O(CR^{1a}R^{1b})ₙ]ₘNH₂;

xi) heterogeneous backbone alkoxy polyalkylene glycol amine units having the formula:

R³[O(CR^{1a}R^{1b})ₙ]ₘ[O(CR^{2a}R^{2b})ⱼ]ₖNH—;

which can derive from alkoxy polyalkylene glycol amines having the formula:

R³[O(CR^{1a}R^{1b})ₙ]ₘ[O(CR^{2a}R^{2b})ⱼ]ₖNH₂;

xii) homogeneous backbone alkyl thiol units having the formula:

R³[(CR^{1a}R^{1b})ₙ]ₘS—;

which can derive from alkyl thiols having the formula:

R³[(CR^{1a}R^{1b})ₙ]ₘSH;

xiii) homogeneous polyalkyleneoxy thiol units having the formula:

H[O(CR^{1a}R^{1b})ₙ]ₘS— or —[O(CR^{1a}R^{1b})ₙ]ₘS—;

which can derive from polyalkyleneoxy thiols having the formula:

H[O(CR^{1a}R^{1b})ₙ]ₘSH;

xiv) heterogeneous polyalkyleneoxy thiol units having the formula:

H[O(CR^{1a}R^{1b})ₙ]ₘ[O(CR^{2a}R^{2b})ⱼ]ₖS— or —[O(CR^{1a}R^{1b})ₙ]ₘ[O(CR^{2a}R^{2b})ⱼ]ₖS—;

which can derive from polyalkyleneoxy thiols having the formula:

H[O(CR^{1a}R^{1b})ₙ]ₘ[O(CR^{1a}R^{1b})ⱼ]ₖSH;

xv) homogeneous polyalkyleneoxy dithiol units having the formula:

—SCR^{1a}R^{1b}[O(CR^{1a}R^{1b})ₙ]ₘSH or —SCR^{1a}R^{1b}[O(CR^{1a}R^{1b})ₙ]ₘS—;

which can derive from polyalkyleneoxy dithiols having the formula:

HSCR^{1a}R^{1b}[O(CR^{1a}R^{1b})ₙ]ₘSH;

xvi) heterogeneous backbone polyalkyleneoxy dithiol units having the formula:

HSCR^{1a}R^{1b}[O(CR^{1a}R^{1b})ₙ]ₘ[O(C^{2a}R^{2b})ⱼ]ₖSH or —SCR^{1a}R^{1b}[O(CR^{1a}R^{1b})ₙ]ₘ[O(CR^{2a}R^{2b})ⱼ]ₖS—;

which can derive from polyalkyleneoxy dithiols having the formula:

HSCR^{1a}R^{1b}[O(CR^{1a}R^{1b})ₙ]ₘ[O(CR^{2a}R^{2b})ⱼ]ₖSH;

xvii) homogeneous backbone alkoxy polyalkyleneoxy thiol units having the formula:

R³[O(CR^{1a}R^{1b})ₙ]ₘS—;

which can derive from alkoxy polyalkyleneoxy thiols having the formula:

R³[O(CR^{1a}R^{1b})ₙ]ₘSH; and

xviii) heterogeneous backbone alkoxy polyalkyleneoxy thiol units having the formula:

R³[O(CR^{1a}R^{1b})ₙ]ₘ[O(CR^{2a}R^{2b})ⱼ]ₖS—;

which can derive from alkoxy polyalkyleneoxy thiols having the formula:

R³[O(CR^{1a}R^{1b})ₙ]ₘ[O(CR^{2a}R^{2b})ⱼ]ₖSH;

wherein each R^{1a} and R^{1b} is independently chosen from hydrogen and C₁-C₂ alkyl; R^{2a} and

R^{2b} is independently chosen from hydrogen and C₁-C₂ alkyl; R³ is C₁-C₄ linear alkyl; the index n is from 2 to 6, the index j is from 3 to 6, the indices m and k are each independently from 1 to 500; provided the index n and the index j are not the same.

In one embodiment that encompasses polyethylene glycol units, the index n is an integer equal to 2 and the index m is an integer from about 10 to about 500. In a further embodiment that encompasses alkyl amines, the index n is an integer from 2 to about 10, while in another embodiment the index n is equal to 5 and R³ is methyl.

### R^{a} and R^{b} Units

R^{a} and R^{b} units when present end or truncate the disclosed polymers. As depicted above in Scheme I, when an Init unit is present that terminates the polymer chain, as in the case of the alkyl amine of Scheme I, then the index m is equal to 0 and the R^{a} unit is absent. In this instance R^{a} is a “non-reacting unit.” The same circumstance can affect the presence or absence of R^{b} units.

By “non-reacting units” is meant a unit that truncates a polymer chain such that no further polymerization can take place. Non-limiting examples of non-reactive units includes C₁-C₂₀ alkyl and C₆ or C₁₀ aryl. As described above, in many instances the non-reactive unit is part of the Init unit, for example, when MPEG units, alkyl amines, alkyl alcohols, alkyl thiols, and the like, are used as a polymerization initiating unit. In these instances, the terminal methyl group of the MPEG, alkyl amine, alkyl alcohol, or alkyl thiol serves as a non-reacting unit that terminates or truncates one end of the polymer.

When present, the disclosed R^{a} and R^{b} units are each independently chosen from:

i) hydrogen;

ii) reacting units; and

iii) protecting groups.

By “non-reacting units” is meant a unit that truncates a polymer chain such that no further polymerization can take place. Non-limiting examples of non-reactive units includes C₁-C₂₀ alkyl and C₆ or C₁₀ aryl. In many instances the non-reactive unit is part of the Init unit, for example, when MPEG units are used as a polymerization initiating unit, the terminal methyl group of the MPEG unit serves as a non-reacting unit.

By “reacting units” is meant a unit that is capable of further reaction. The reacting units can be added before or after the polymerization reactions that form the disclosed polymers if the reacting units do not participate in the formation of the polymer chain.

One embodiment of reacting units includes leaving groups, for example, halogen, tosyl, mesyl, and the like.

Another embodiment of reacting units includes, for example, isocyanate, isothiocyanate, —C(O)Cl, and the like.

In a further embodiment, R^{a} and R^{b} can also be any protecting group that can be selectively removed so that the polymer can be further modified by the formulator. In one iteration of this embodiment, the AA unit comprises protected amino acids having the same protecting group or groups as the R^{a} and R^{b} units. In another iteration, the AA unit comprises protected amino acids having a different protecting group or groups than the R^{a} and R^{b} units. In a further iteration, the AA unit comprises one or more protected amino acids having different protecting groups than either R^{a} or R^{b} and R^{a} and R^{b} have different protecting groups from one another. In a still further embodiment, R^{a} or R^{b} can comprise a protecting group while the other of R^{a} or R^{b} can comprise a reacting unit.

The disclosed polymers are ultra pure, mono-disperse polymers having no metal contamination. The polymers have the formula:

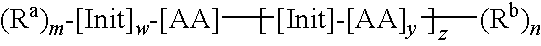

AA, Init, R^{a}, R^{b}, and the indices m, n, w, x, y, and z are further defined and exemplified in the following examples and the appended claims.

A first category of the disclosed polymers are homopolymers having the formula:

[Init]-[AA]ₓ-(R^{b})ₙ

wherein Init is an unit derived from a polymerization initiator, AA is a homopolymer of an amino acid or a homopolymer of a protected amino acid, R^{b} is hydrogen, a protecting group, or a unit that is capable of further reacting the polymer with one or more substrates, the index x is from about 10 to about 40.

A first embodiment of this category relates to polymers wherein AA is a homopolymer of an amino acid and R^{b} is hydrogen. Non-limiting iterations of this embodiment include:
i) R³(CR^{1a}R^{1b})ₙNH-(L-lysine)ₓ-H; an example of which can be represented by the formula:

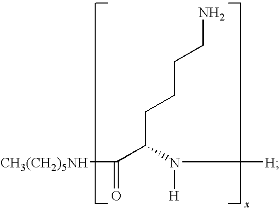

Non-limiting examples this iteration include:
   CH₃(CH₂)₅NH-(L-lysine)₁₀-H;
   CH₃(CH₂)₅NH-(L-lysine)₁₀₀-H;
   CH₃(CH₂)₅NH-(L-lysine)₂₀₀-H;
   CH₃(CH₂)₅NH-(D,L-lysine)₁₀-H;
   CH₃(CH₂)₅NH-(D,L-lysine)₁₀₀-H;
   CH₃(CH₂)₅NH-(D,L-lysine)₂₀₀-H;
   CH₃(CH₂)₆NH-(L-lysine)₁₀-H;
   CH₃(CH₂)₆NH-(L-lysine)₁₀₀-H;
   CH₃(CH₂)₆NH-(L-lysine)₂₀₀-H;
   CH₃(CH₂)₆NH-(D,L-lysine)₁₀-H;
   CH₃(CH₂)₆NH-(D,L-lysine)₁₀₀-H; and
   CH₃(CH₂)₆NH-(D,L-lysine)₂₀₀-H.
ii) R³(CR^{1a}R^{1b})ₙNH-(L-aspartic acid)ₓ-H; non-limiting examples this iteration include:
   CH₃(CH₂)₅NH-(L-aspartic acid)₁₀-H;
   CH₃(CH₂)₅NH-(L-aspartic acid)₁₀₀-H;
   CH₃(CH₂)₅NH-(L-aspartic acid)₂₀₀-H;
   CH₃(CH₂)₅NH-(D,L-aspartic acid)₁₀-H;
   CH₃(CH₂)₅NH-(D,L-aspartic acid)₁₀₀-H; and
   CH₃(CH₂)₅NH-(D,L-aspartic acid)₂₀₀-H;
iii) R³(CR^{1a}R^{1b})ₙNH-(L-glutamic acid)ₓ-H; non-limiting examples this iteration include:
   CH₃(CH₂)₅NH-(L-glutamic acid)₁₀-H;
   CH₃(CH₂)₅NH-(L-glutamic acid)₁₀₀-H;
   CH₃(CH₂)₅NH-(L-glutamic acid)₂₀₀-H;
   CH₃(CH₂)₅NH-(D,L-glutamic acid)₁₀-H;
   CH₃(CH₂)₅NH-(D,L-glutamic acid)₁₀₀-H; and
   CH₃(CH₂)₅NH-(D,L-glutamic acid)₂₀₀-H;
iv) R³(CR^{1a}R^{1b})ₙNH-(L-ornithine)ₓ-H; non-limiting examples this iteration include:
   CH₃(CH₂)₅NH-(L-ornithine)₁₀-H;
   CH₃(CH₂)₅NH-(L-ornithine)₁₀₀-H;
   CH₃(CH₂)₅NH-(L-ornithine)₂₀₀-H;
   CH₃(CH₂)₅NH-(D,L-ornithine)₁₀-H;
   CH₃(CH₂)₅NH-(D,L-ornithine)₁₀₀-H; and
   CH₃(CH₂)₅NH-(D,L-ornithine)₂₀₀-H;
v) R³(CR^{1a}R^{1b})ₙNH-(L-cysteine)ₓ-H; non-limiting examples this iteration include:
   CH₃(CH₂)₅NH-(L-cysteine)₁₀-H;
   CH₃(CH₂)₅NH-(L-cysteine)₁₀₀-H;
   CH₃(CH₂)₅NH-(L-cysteine)₂₀₀-H;
   CH₃(CH₂)₅NH-(D,L-cysteine)₁₀-H;
   CH₃(CH₂)₅NH-(D,L-cysteine)₁₀₀-H; and
   CH₃(CH₂)₅NH-(D,L-cysteine)₂₀₀-H;
vi R³(CR^{1a}R^{1b})ₙNH-(L-serine)ₓ-H; non-limiting examples this iteration include:
   CH₃(CH₂)₅NH-(L-serine)₁₀-H;
   CH₃(CH₂)₅NH-(L-serine)₁₀₀-H;
   CH₃(CH₂)₅NH-(L-serine)₂₀₀-H;
   CH₃(CH₂)₅NH-(D,L-serine)₁₀-H;
   CH₃(CH₂)₅NH-(D,L-serine)₁₀₀-H; and
   CH₃(CH₂)₅NH-(D,L-serine)₂₀₀-H;
vii) R³(CR^{1a}R^{1b})ₙNH-(L-threonine)ₓ-H; non-limiting examples this iteration include:
   CH₃(CH₂)₅NH-(L-threonine)₁₀-H;
   CH₃(CH₂)₅NH-(L-threonine)₁₀₀-H;
   CH₃(CH₂)₅NH-(L-threonine)₂₀₀-H;
   CH₃(CH₂)₅NH-(D,L-threonine)₁₀-H;
   CH₃(CH₂)₅NH-(D,L-threonine)₁₀₀-H; and
   CH₃(CH₂)₅NH-(D,L-threonine)₂₀₀-H;
viii) R³(CR^{1a}R^{1b})ₙNH-(L-arginine)ₙ-H; non-limiting examples this iteration include:
   CH₃(CH₂)₅NH-(L-arginine)₁₀-H;
   CH₃(CH₂)₅NH-(L-arginine)₁₀₀-H;
   CH₃(CH₂)₅NH-(L-arginine)₂₀₀-H;
   CH₃(CH₂)₅NH-(D,L-arginine)₁₀-H;
   CH₃(CH₂)₅NH-(D,L-arginine)₁₀₀-H; and
   CH₃(CH₂)₅NH-(D,L-arginine)₂₀₀-H;
ix) R³(OCR^{1a}R^{1b})ₙO-(L-lysine)ₓ-H; non-limiting examples this iteration include:
   MPEG(4000)O-(L-lysine)₁₀-H;
   MPEG(4000)O-(L-lysine)₁₀₀-H;
   MPEG(4000)O-(L-lysine)₂₀₀-H;
   MPEG(5000)O-(L-lysine)₁₀-H;
   MPEG(5000)O-(L-lysine)₁₀₀-H;
   MPEG(5000)O-(L-lysine)₂₀₀-H;
   MPEG(8000)O-(L-lysine)₁₀-H;
   MPEG(8000)O-(L-lysine)₁₀₀-H; and
   MPEG(8000)O-(L-lysine)₂₀₀-H;
x) R³(OCR^{1a}R^{1b})ₙO-(L-aspartic acid)ₓ-H; non-limiting examples this iteration include:
   MPEG(4000)O-(L-aspartic acid)₁₀-H;
   MPEG(4000)O-(L-aspartic acid)₁₀₀-H;
   MPEG(4000)O-(L-aspartic acid)₂₀₀-H;
   MPEG(5000)O-(L-aspartic acid)₁₀-H;
   MPEG(5000)O-(L-aspartic acid)₁₀₀-H;
   MPEG(5000)O-(L-aspartic acid)₂₀₀-H;
   MPEG(8000)O-(L-aspartic acid)₁₀-H;
   MPEG(8000)O-(L-aspartic acid)₁₀₀-H; and
   MPEG(8000)O-(L-aspartic acid)₂₀₀-H;
xi) R³(OCR^{1a}R^{1b})ₙO-(L-glutamic acid)ₓ-H; non-limiting examples this iteration include:
   MPEG(4000)O-(L-glutamic acid)₁₀-H;
   MPEG(4000)O-(L-glutamic acid)₁₀₀-H;
   MPEG(4000)O-(L-glutamic acid)₂₀₀-H;
   MPEG(5000)O-(L-glutamic acid)₁₀-H;
   MPEG(5000)O-(L-glutamic acid)₁₀₀-H;
   MPEG(5000)O-(L-glutamic acid)₂₀₀-H;
   MPEG(8000)O-(L-glutamic acid)₁₀-H;
   MPEG(8000)O-(L-glutamic acid)₁₀₀-H; and
   MPEG(8000)O-(L-glutamic acid)₂₀₀-H;
xii) R³(OCR^{1a}R^{1b})ₙO-(L-ornithine)ₓ-H; non-limiting examples this iteration include:
   MPEG(4000)O-(L-ornithine)₁₀-H;
   MPEG(4000)O-(L-ornithine)₁₀₀-H;
   MPEG(4000)O-(L-ornithine)₂₀₀-H;
   MPEG(5000)O-(L-ornithine)₁₀-H;
   MPEG(5000)O-(L-ornithine)₁₀₀-H;
   MPEG(5000)O-(L-ornithine)₂₀₀-H;
   MPEG(8000)O-(L-ornithine)₁₀-H;
   MPEG(8000)O-(L-ornithine)₁₀₀-H; and
   MPEG(8000)O-(L-ornithine)₂₀₀-H;
xiii) R³(OCR^{1a}R^{1b})ₙO-(L-cysteine)ₓ-H; non-limiting examples this iteration include:
   MPEG(4000)O-(L-cysteine)₁₀-H;
   MPEG(4000)O-(L-cysteine)₁₀₀-H;
   MPEG(4000)O-(L-cysteine)₂₀₀-H;
   MPEG(5000)O-(L-cysteine)₁₀-H;
   MPEG(5000)O-(L-cysteine)₁₀₀-H;
   MPEG(5000)O-(L-cysteine)₂₀₀-H;
   MPEG(8000)O-(L-cysteine)₁₀-H;
   MPEG(8000)O-(L-cysteine)₁₀₀-H; and
   MPEG(8000)O-(L-cysteine)₂₀₀-H;
xiv) R³(OCR^{1a}R^{1b})ₙO-(L-serine)ₓ-H; non-limiting examples this iteration include:
   MPEG(4000)O-(L-serine)₁₀-H;
   MPEG(4000)O-(L-serine)₁₀₀-H;
   MPEG(4000)O-(L-serine)₂₀₀-H;
   MPEG(5000)O-(L-serine)₁₀-H;
   MPEG(5000)O-(L-serine)₁₀₀-H;
   MPEG(5000)O-(L-serine)₂₀₀-H;
   MPEG(8000)O-(L-serine)₁₀-H;
   MPEG(8000)O-(L-serine)₁₀₀-H; and
   MPEG(8000)O-(L-serine)₂₀₀-H;
xv) R³(OCR^{1a}R^{1b})ₙO-(L-threonine)ₓ-H; non-limiting examples this iteration include:
   MPEG(4000)O-(L-threonine)₁₀-H;
   MPEG(4000)O-(L-threonine)₁₀₀-H;
   MPEG(4000)O-(L-threonine)₂₀₀-H;
   MPEG(5000)O-(L-threonine)₁₀-H;
   MPEG(5000)O-(L-threonine)₁₀₀-H;
   MPEG(5000)O-(L-threonine)₂₀₀-H;
   MPEG(8000)O-(L-threonine)₁₀-H;
   MPEG(8000)O-(L-threonine)₁₀₀-H; and
   MPEG(8000)O-(L-threonine)₂₀₀-H;
xvi) R³(OCR^{1a}R^{1b})ₙO-(L-arginine)ₓ-H; non-limiting examples this iteration include:
   MPEG(4000)O-(L-arginine)₁₀-H;
   MPEG(4000)O-(L-arginine)₁₀₀-H;
   MPEG(4000)O-(L-arginine)₂₀₀-H;
   MPEG(5000)O-(L-arginine)₁₀-H;
   MPEG(5000)O-(L-arginine)₁₀₀-H;
   MPEG(5000)O-(L-arginine)₂₀₀-H;
   MPEG(8000)O-(L-arginine)₁₀-H;
   MPEG(8000)O-(L-arginine)₁₀₀-H; and
   MPEG(8000)O-(L-arginine)₂₀₀-H; Another embodiment of this category relates to polymers wherein AA is a homopolymer of a protected amino acid and R^{b} is hydrogen. Non-limiting iterations of this embodiment include:
Non-limiting examples this iteration include:
CH₃(CH₂)₅NH-(ω-Cbz-L-lysine)₁₀-H;
CH₃(CH₂)₅NH-(ω-Cbz-L-lysine)₁₀₀-H;
CH₃(CH₂)₅NH-(ω-Cbz-L-lysine)₂₀₀-H;
CH₃(CH₂)₅NH-(ω-Boc-L-lysine)₁₀-H;
CH₃(CH₂)₅NH-(ω-Boc-L-lysine)₁₀₀-H;
CH₃(CH₂)₅NH-(ω-Boc-L-lysine)₂₀₀-H;
CH₃(CH₂)₆NH-(ω-TFA-L-lysine)₁₀-H;
CH₃(CH₂)₆NH-(ω-TFA-L-lysine)₁₀₀-H;
CH₃(CH₂)₆NH-(ω-TFA-L-lysine)₂₀₀-H;
MPEG(5000)O-(ω-Cbz-L-lysine)₁₀-H;
MPEG(5000)O-(ω-Cbz-L-lysine)₁₀₀-H;
MPEG(5000)O-(ω-Cbz-L-lysine)₂₀₀-H;
MPEG(5000)O-(ω-Boc-L-lysine)₁₀-H;
MPEG(5000)O-(ω-Boc-L-lysine)₁₀₀-H;
MPEG(5000)O-(ω-Boc-L-lysine)₂₀₀-H;
MPEG(5000)O-(ω-TFA-L-lysine)₁₀-H;
MPEG(5000)O-(ω-TFA-L-lysine)₁₀₀-H; and
MPEG(5000)O-(ω-TFA-L-lysine)₂₀₀-H.

Another embodiment of this category relates to polymers wherein R^{b} is a protecting group. A first iteration of this embodiment relates to polymers wherein R^{b} comprises a protecting group but the AA unit does not comprise an amino acid having a protecting group. The following are non-limiting examples of this iteration:
CH₃(CH₂)₅NH-(L-lysine)₁₀-Cbz;
CH₃(CH₂)₅NH-(L-lysine)₁₀₀-Cbz;
CH₃(CH₂)₅NH-(L-lysine)₂₀₀-Cbz;
CH₃(CH₂)₅NH-(L-lysine)₁₀-TFA;
CH₃(CH₂)₅NH-(L-lysine)₁₀₀-TFA;
CH₃(CH₂)₅NH-(L-lysine)₂₀₀-TFA;
CH₃(CH₂)₅NH-(L-lysine)₁₀-Benzyl;
CH₃(CH₂)₅NH-(L-lysine)₁₀₀-Benzyl;
CH₃(CH₂)₅NH-(L-lysine)₂₀₀-Benzyl;
CH₃(CH₂)₅NH-(L-lysine)₁₀-Fmoc;
CH₃(CH₂)₅NH-(L-lysine)₁₀₀-Fmoc;
CH₃(CH₂)₅NH-(L-lysine)₂₀₀-Fmoc;
MPEG(5000)O-(L-lysine)₁₀-Cbz;
MPEG(5000)O-(L-lysine)₁₀₀-Cbz;
MPEG(5000)O-(L-lysine)₂₀₀-Cbz;
MPEG(5000)O-(L-lysine)₁₀-TFA;
MPEG(5000)O-(L-lysine)₁₀₀-TFA MPEG(5000)O-(L-lysine)₂₀₀-TFA;
MPEG(5000)O-(L-lysine)₁₀-Benzyl;
MPEG(5000)O-(L-lysine)₁₀₀-Benzyl;
MPEG(5000)O-(L-lysine)₂₀₀-Benzyl;
MPEG(5000)O-(L-lysine)₁₀-Fmoc;
MPEG(5000)O-(L-lysine)₁₀₀-Fmoc; and
MPEG(5000)O-(L-lysine)₂₀₀-Fmoc.

Another iteration of this embodiment relates to polymers wherein R^{b} comprises a protecting group that can be removed from the protecting group of protected amino acids that comprise the AA unit in a manner that does not affect the AA unit protecting group. The following are non-limiting examples of this iteration:
CH₃(CH₂)₅NH-(ω-Cbz-L-lysine)₁₀-Boc;
CH₃(CH₂)₅NH-(ω-Cbz-L-lysine)₁₀₀-Boc;
CH₃(CH₂)₅NH-(ω-Cbz-L-lysine)₂₀₀-Boc;
CH₃(CH₂)₅NH-(ω-Boc-L-lysine)₁₀-Cbz;
CH₃(CH₂)₅NH-(ω-Boc-L-lysine)₁₀₀-Cbz;
CH₃(CH₂)₅NH-(ω-Boc-L-lysine)₂₀₀-Cbz;
CH₃(CH₂)₆NH-(ω-TFA-L-lysine)₁₀₀-Cbz;
CH₃(CH₂)₆NH-(ω-TFA-L-lysine)₁₀₀-Cbz;
CH₃(CH₂)₆NH-(ω-TFA-L-lysine)₂₀₀-Cbz;
MPEG(5000)O-(ω-Cbz-L-lysine)₁₀-Boc;
MPEG(5000)O-(ω-Cbz-L-lysine)₁₀₀-Boc;
MPEG(5000)O-(ω-Cbz-L-lysine)₂₀₀-Boc;
MPEG(5000)O-(ω-Boc-L-lysine)₁₀-Cbz;
MPEG(5000)O-(ω-Boc-L-lysine)₁₀₀-Cbz;
MPEG(5000)O-(ω-Boc-L-lysine)₂₀₀-Cbz;
MPEG(5000)O-(ω-TFA-L-lysine)₁₀-Cbz;
MPEG(5000)O-(ω-TFA-L-lysine)₁₀₀-Cbz; and
MPEG(5000)O-(ω-TFA-L-lysine)₂₀₀-Cbz.

Another category of the disclosed polymers are polymers having the formula:

[Init]-[AA]ₓ-(R^{b})ₙ

wherein Init is a unit derived from a polymerization initiator, AA is a random copolymer that comprises an admixture of unprotected residues of at least two amino acids, R^{b} is hydrogen, a protecting group, or a unit that is capable of further reacting the polymer with one or more substrates, the index x is from about 10 to about 40.

One embodiment of this category includes:
CH₃(CH₂)₅NH-[(L-lysine)₉₀(L-cysteine)₁₀]-H;
CH₃(CH₂)₅NH-[(L-lysine)₈₀(L-cysteine)₂₀]-H;
CH₃(CH₂)₅NH-[(L-lysine)₇₀(L-cysteine)₃₀]-H;
CH₃(CH₂)₅NH-[(L-lysine)₆₀(L-cysteine)₄₀]-H;
CH₃(CH₂)₅NH-[(L-lysine)₅₀(L-cysteine)₅₀]-H;
CH₃(CH₂)₅NH-[(L-lysine)₄₀(L-cysteine)₆₀]-H;
CH₃(CH₂)₅NH-[(L-lysine)₃₀(L-cysteine)₇₀]-H;
CH₃(CH₂)₅NH-[(L-lysine)₂₀(L-cysteine)₈₀]-H;
CH₃(CH₂)₅NH-[(L-lysine)₁₀(L-cysteine)₉₀]-H;
CH₃(CH₂)₅NH-[(L-lysine)₃₀₀(L-cysteine)₁₀₀]-H;
CH₃(CH₂)₅NH-[(L-lysine)₂₅₀(L-cysteine)₁₅₀]-H;
CH₃(CH₂)₅NH-[(L-lysine)₂₀₀(L-cysteine)₂₀₀]-H;
CH₃(CH₂)₅NH-[(L-lysine)₁₅₀(L-cysteine)₂₅₀]-H;
CH₃(CH₂)₅NH-[(L-lysine)₁₀₀(L-cysteine)₃₀₀]-H;
MPEG(5000)O-[(L-lysine)₉₀(L-cysteine)₁₀]-H;
MPEG(5000)O-[(L-lysine)₈₀(L-cysteine)₂₀]-H;
MPEG(5000)O-[(L-lysine)₇₀(L-cysteine)₃₀]-H;
MPEG(5000)O-[(L-lysine)₆₀(L-cysteine)₄₀]-H;
MPEG(5000)O-[(L-lysine)₅₀(L-cysteine)₅₀]-H;
MPEG(5000)O-[(L-lysine)₄₀(L-cysteine)₆₀]-H;
MPEG(5000)O-[(L-lysine)₃₀(L-cysteine)₇₀]-H;
MPEG(5000)O-[(L-lysine)₂₀(L-cysteine)₈₀]-H;
MPEG(5000)O-[(L-lysine)₁₀(L-cysteine)₉₀]-H;
MPEG(5000)O-[(L-lysine)₃₀(L-cysteine)₇₀]-H;
MPEG(5000)O-[(L-lysine)₃₀₀(L-cysteine)₁₀₀]-H;
MPEG(5000)O-[(L-lysine)₂₅₀(L-cysteine)₁₅₀]-H;
MPEG(5000)O-[(L-lysine)₂₀₀(L-cysteine)₂₀₀]-H;
MPEG(5000)O-[(L-lysine)₁₅₀(L-cysteine)₂₅₀]-H; and
MPEG(5000)O-[(L-lysine)₁₀₀(L-cysteine)₃₀₀]-H.

Another category of the disclosed polymers are polymers having the formula:

[Init]-[AA]ₓ-(R^{b})ₙ

wherein Init is a unit derived from a polymerization initiator, AA is a random copolymer that comprises an admixture of protected residues of at least two amino acids, R^{b} is hydrogen, a protecting group, or a unit that is capable of further reacting the polymer with one or more substrates, the index x is from about 10 to about 40.

One embodiment of this category includes:
CH₃(CH₂)₅NH-[(ω-Cbz-L-lysine)₉₀(S-carboxymethyl-L-cysteine)₁₀]-H;
CH₃(CH₂)₅NH-[(ω-Cbz-L-lysine)₈₀(S-carboxymethyl-L-cysteine)₂₀]-H;
CH₃(CH₂)₅NH-[(ω-Cbz-L-lysine)₇₀(S-carboxymethyl-L-cysteine)₃₀]-H;
CH₃(CH₂)₅NH-[(ω-Cbz-L-lysine)₆₀(S-carboxymethyl-L-cysteine)₄₀]-H;
CH₃(CH₂)₅NH-[(ω-Cbz-L-lysine)₅₀(S-carboxymethyl-L-cysteine)₅₀]-H;
CH₃(CH₂)₅NH-[(ω-Cbz-L-lysine)₄₀(S-carboxymethyl-L-cysteine)₆₀]-H;
CH₃(CH₂)₅NH-[(ω-Cbz-L-lysine)₃₀(S-carboxymethyl-L-cysteine)₇₀]-H;
CH₃(CH₂)₅NH-[(ω-Cbz-L-lysine)₂₀(S-carboxymethyl-L-cysteine)₈₀]-H;
CH₃(CH₂)₅NH-[(ω-Cbz-L-lysine)₁₀(S-carboxymethyl-L-cysteine)₉₀]-H;
CH₃(CH₂)₅NH-[(ω-Cbz-L-lysine)₁₀(S-carboxymethyl-L-cysteine)₁₀]-Boc;
CH₃(CH₂)₅NH-[(ω-Cbz-L-lysine)₈₀(S-carboxymethyl-L-cysteine)₂₀]-Boc;
CH₃(CH₂)₅NH-[(ω-Cbz-L-lysine)₇₀(S-carboxymethyl-L-cysteine)₃₀]-Boc;
CH₃(CH₂)₅NH-[(ω-Cbz-L-lysine)₆₀(S-carboxymethyl-L-cysteine)₄₀]-Boc;
CH₃(CH₂)₅NH-[(ω-Cbz-L-lysine)₅₀(S-carboxymethyl-L-cysteine)₅₀]-Boc;
CH₃(CH₂)₅NH-[(ω-Cbz-L-lysine)₄₀(S-carboxymethyl-L-cysteine)₆₀]-Boc;
CH₃(CH₂)₅NH-[(ω-Cbz-L-lysine)₃₀(S-carboxymethyl-L-cysteine)₇₀]-Boc;
CH₃(CH₂)₅NH-[(ω-Cbz-L-lysine)₂₀(S-carboxymethyl-L-cysteine)₈₀]-Boc;
CH₃(CH₂)₅NH-[(ω-Cbz-L-lysine)₁₀(S-carboxymethyl-L-cysteine)₉₀]-Boc;
CH₃(CH₂)₅NH-[(ω-Cbz-L-lysine)₈₀(S-carboxymethyl-L-cysteine)₁₀]-succinimide;
CH₃(CH₂)₅NH-[(ω-Cbz-L-lysine)₈₀(S-carboxymethyl-L-cysteine)₂₀]-succinimide;
CH₃(CH₂)₅NH-[(ω-Cbz-L-lysine)₇₀(S-carboxymethyl-L-cysteine)₃₀]-succinimide;
CH₃(CH₂)₅NH-[(ω-Cbz-L-lysine)₆₀(S-carboxymethyl-L-cysteine)₄₀]-succinimide;
CH₃(CH₂)₅NH-[(ω-Cbz-L-lysine)₅₀(S-carboxymethyl-L-cysteine)₅₀]-succinimide;
CH₃(CH₂)₅NH-[(ω-Cbz-L-lysine)₄₀(S-carboxymethyl-L-cysteine)₆₀]-succinimide;
CH₃(CH₂)₅NH-[(ω-Cbz-L-lysine)₃₀(S-carboxymethyl-L-cysteine)₇₀]-succinimide;
CH₃(CH₂)₅NH-[(ω-Cbz-L-lysine)₂₀(S-carboxymethyl-L-cysteine)₈₀]-succinimide; and
CH₃(CH₂)₅NH-[(ω-Cbz-L-lysine)₁₀(S-carboxymethyl-L-cysteine)₉₀]-succinimide.

Another embodiment of this category includes:
CH₃(CH₂)₅NH-[(ω-Cbz-L-lysine)₉₀(ω-Bnz-L-aspartic acid)₁₀]-H;
CH₃(CH₂)₅NH-[(ω-Cbz-L-lysine)₉₀(ω-Bnz-L-aspartic acid)₂₀]-H;
CH₃(CH₂)₅NH-[(ω-Cbz-L-lysine)₇₀(ω-Bnz-L-aspartic acid)₃₀]-H;
CH₃(CH₂)₅NH-[(ω-Cbz-L-lysine)₆₀(ω-Bnz-L-aspartic acid)₄₀]-H;
CH₃(CH₂)₅NH-[(ω-Cbz-L-lysine)₅₀(ω-Bnz-L-aspartic acid)₅₀]-H;
CH₃(CH₂)₅NH-[(ω-Cbz-L-lysine)₄₀(ω-Bnz-L-aspartic acid)₆₀]-H;
CH₃(CH₂)₅NH-[(ω-Cbz-L-lysine)₃₀(ω-Bnz-L-aspartic acid)₇₀]-H;
CH₃(CH₂)₅NH-[(ω-Cbz-L-lysine)₂₀(ω-Bnz-L-aspartic acid)₈₀]-H;
CH₃(CH₂)₅NH-[(ω-Cbz-L-lysine)₁₀(ω-Bnz-L-aspartic acid)₉₀]-H;
CH₃(CH₂)₅NH-[(ω-Cbz-L-lysine)₉₀(ω-Bnz-L-aspartic acid)₁₀]-Boc;
CH₃(CH₂)₅NH-[(ω-Cbz-L-lysine)₈₀(ω-Bnz-L-aspartic acid)₂₀]-Boc;
CH₃(CH₂)₅NH-[(ω-Cbz-L-lysine)₇₀(ω-Bnz-L-aspartic acid)₃₀]-Boc;
CH₃(CH₂)₅NH-[(ω-Cbz-L-lysine)₆₀(ω-Bnz-L-aspartic acid)₄₀]-Boc;
CH₃(CH₂)₅NH-[(ω-Cbz-L-lysine)₅₀(ω-Bnz-L-aspartic acid)₅₀]-Boc;
CH₃(CH₂)₅NH-[(ω-Cbz-L-lysine)₄₀(ω-Bnz-L-aspartic acid)₆₀]-Boc;
CH₃(CH₂)₅NH-[(ω-Cbz-L-lysine)₃₀(ω-Bnz-L-aspartic acid)₇₀]-Boc;
CH₃(CH₂)₅NH-[(ω-Cbz-L-lysine)₂₀(ω-Bnz-L-aspartic acid)₈₀]-Boc; and
CH₃(CH₂)₅NH-[(ω-Cbz-L-lysine)₁₀(ω-Bnz-L-aspartic acid)₉₀]-Boc.

A further embodiment of this category includes:
MPEG(5000)O-[(ω-Cbz-L-lysine)₉₀(S-carboxymethyl-L-cysteine)₁₀]-H;
MPEG(5000)O-[(ω-Cbz-L-lysine)₈₀(S-carboxymethyl-L-cysteine)₂₀]-H;
MPEG(5000)O-[(ω-Cbz-L-lysine)₇₀(S-carboxymethyl-L-cysteine)₃₀]-H;
MPEG(5000)O-[(ω-Cbz-L-lysine)₆₀(S-carboxymethyl-L-cysteine)₄₀]-H;
MPEG(5000)O-[(ω-Cbz-L-lysine)₅₀(S-carboxymethyl-L-cysteine)₅₀]-H;
MPEG(5000)O-[(ω-Cbz-L-lysine)₄₀(S-carboxymethyl-L-cysteine)₆₀]-H;
MPEG(5000)O-[(ω-Cbz-L-lysine)₃₀(S-carboxymethyl-L-cysteine)₇₀]-H;
MPEG(5000)O-[(ω-Cbz-L-lysine)₂₀(S-carboxymethyl-L-cysteine)₉₀]-H;
MPEG(5000)O-[(ω-Cbz-L-lysine)₁₀(S-carboxymethyl-L-cysteine)₉₀]-H;
MPEG(5000)O-[(ω-Cbz-L-lysine)₉₀(S-carboxymethyl-L-cysteine)₁₀]-Boc;
MPEG(5000)O-[(ω-Cbz-L-lysine)₈₀(S-carboxymethyl-L-cysteine)₂₀]-Boc;
MPEG(5000)O-[(ω-Cbz-L-lysine)₇₀(S-carboxymethyl-L-cysteine)₃₀]-Boc;
MPEG(5000)O-[(ω-Cbz-L-lysine)₆₀(S-carboxymethyl-L-cysteine)₄₀]-Boc;
MPEG(5000)O-[(ω-Cbz-L-lysine)₅₀(S-carboxymethyl-L-cysteine)₅₀]-Boc;
MPEG(5000)O-[(ω-Cbz-L-lysine)₄₀(S-carboxymethyl-L-cysteine)₆₀]-Boc;
MPEG(5000)O-[(ω-Cbz-L-lysine)₃₀(S-carboxymethyl-L-cysteine)₇₀]-Boc;
MPEG(5000)O-[(ω-Cbz-L-lysine)₂₀(S-carboxymethyl-L-cysteine)₈₀]-Boc; and
MPEG(5000)O-[(ω-Cbz-L-lysine)₁₀(S-carboxymethyl-L-cysteine)₉₀]-Boc.

A yet further embodiment of the category includes:
MPEG(5000)O-[(ω-Cbz-L-lysine)₉₀(ω-Bnz-L-aspartic acid)₁₀]-H;
MPEG(5000)O-[(ω-Cbz-L-lysine)₈₀(ω-Bnz-L-aspartic acid)₂₀]-H;
MPEG(5000)O-[(ω-Cbz-L-lysine)₇₀(ω-Bnz-L-aspartic acid)₃₀]-H;
MPEG(5000)O-[(ω-Cbz-L-lysine)₆₀(ω-Bnz-L-aspartic acid)₄₀]-H;
MPEG(5000)O-[(ω-Cbz-L-lysine)₅₀(ω-Bnz-L-aspartic acid)₅₀]-H;
MPEG(5000)O-[(ω-Cbz-L-lysine)₄₀(ω-Bnz-L-aspartic acid)₆₀]-H;
MPEG(5000)O-[(ω-Cbz-L-lysine)₃₀(ω-Bnz-L-aspartic acid)₇₀]-H;
MPEG(5000)O-[(ω-Cbz-L-lysine)₂₀(ω-Bnz-L-aspartic acid)₈₀]-H;
MPEG(5000)O-[(ω-Cbz-L-lysine)₁₀(ω-Bnz-L-aspartic acid)₉₀]-H;
MPEG(5000)O-[(ω-Cbz-L-lysine)₉₀(ω-Bnz-L-aspartic acid)₁₀]-Boc;
MPEG(5000)O-[(ω-Cbz-L-lysine)₈₀(ω-Bnz-L-aspartic acid)₂₀]-Boc;
MPEG(5000)O-[(ω-Cbz-L-lysine)₇₀(ω-Bnz-L-aspartic acid)₃₀]-Boc;
MPEG(5000)O-[(ω-Cbz-L-lysine)₆₀(ω-Bnz-L-aspartic acid)₄₀]-Boc;
MPEG(5000)O-[(ω-Cbz-L-lysine)₅₀(ω-Bnz-L-aspartic acid)₅₀]-Boc;
MPEG(5000)O-[(ω-Cbz-L-lysine)₄₀(ω-Bnz-L-aspartic acid)₆₀]-Boc;
MPEG(5000)O-[(ω-Cbz-L-lysine)₃₀(ω-Bnz-L-aspartic acid)₇₀]-Boc;
MPEG(5000)O-[(ω-Cbz-L-lysine)₂₀(ω-Bnz-L-aspartic acid)₈₀]-Boc;
MPEG(5000)O-[(ω-Cbz-L-lysine)₁₀(ω-Bnz-L-aspartic acid)₉₀]-Boc;
MPEG(5000)O-[(ω-di-Cbz-L-arginine)₉₀(ω-Bnz-L-aspartic acid)₁₀]-H;
MPEG(5000)O-[(ω-di-Cbz-L-arginine)₈₀(ω-Bnz-L-aspartic acid)₂₀]-H;
MPEG(5000)O-[(ω-di-Cbz-L-arginine)₇₀(ω-Bnz-L-aspartic acid)₃₀]-H;
MPEG(5000)O-[(ω-di-Cbz-L-arginine)₆₀(ω-Bnz-L-aspartic acid)₄₀]-H;
MPEG(5000)O-[(ω-di-Cbz-L-arginine)₅₀(ω-Bnz-L-aspartic acid)₅₀]-H;
MPEG(5000)O-[(ω-di-Cbz-L-arginine)₄₀(ω-Bnz-L-aspartic acid)₆₀]-H;
MPEG(5000)O-[(ω-di-Cbz-L-arginine)₃₀(ω-Bnz-L-aspartic acid)₇₀]-H;
MPEG(5000)O-[(ω-di-Cbz-L-arginine)₂₀(ω-Bnz-L-aspartic acid)₈₀]-H;
MPEG(5000)O-[(ω-di-Cbz-L-arginine)₁₀(ω-Bnz-L-aspartic acid)₉₀]-H;
MPEG(5000)O-[(ω-di-Cbz-L-arginine)₉₀(ω-Bnz-L-aspartic acid)₁₀]-Boc;
MPEG(5000)O-[(ω-di-Cbz-L-arginine)₈₀(ω-Bnz-L-aspartic acid)₂₀]-Boc;
MPEG(5000)O-[(ω-di-Cbz-L-arginine)₇₀(ω-Bnz-L-aspartic acid)₃₀]-Boc;
MPEG(5000)O-[(ω-di-Cbz-L-arginine)₆₀(ω-Bnz-L-aspartic acid)₄₀]-Boc;
MPEG(5000)O-[(ω-di-Cbz-L-arginine)₅₀(ω-Bnz-L-aspartic acid)₅₀]-Boc;
MPEG(5000)O-[(ω-di-Cbz-L-arginine)₄₀(ω-Bnz-L-aspartic acid)₆₀]-Boc;
MPEG(5000)O-[(ω-di-Cbz-L-arginine)₃₀(ω-Bnz-L-aspartic acid)₇₀]-Boc;
MPEG(5000)O-[(ω-di-Cbz-L-arginine)₂₀(ω-Bnz-L-aspartic acid)₈₀]-Boc; and
MPEG(5000)O-[(ω-di-Cbz-L-arginine)₁₀(ω-Bnz-L-aspartic acid)₉₀]-Boc.

A yet further category of the disclosed polymers are block copolymers having the formula:

[Init]-[AA]ₓ-(R^{b})ₙ

wherein AA is a block copolymer having the formula:

[AA₁]ₓ_{¹}-[AA₂]ₓ_{²}[AAᵢ]ₓ_{ⁱ}

Init is an unit derived from a polymerization initiator, AA₁ represents a block polymer of a first protected or unprotected amino acid; AA₂ represents a block polymer of a second protected or unprotected amino acid, AAᵢ represents a block polymer of the ith block of protected or unprotected amino acid; R^{b} is hydrogen, a protecting group, or a unit that is capable of further reacting the polymer with one or more substrates, and the indices x¹+x²+ . . . xⁱ=x; the index x is from about 10 to about 400;

One embodiment of this category relates to block copolymers having the formula:

[Init][AA₁]ₓ_{¹}[AA₁]ₓ_{²}H

One iteration of this embodiment relates to block copolymers having the formula:

R³(CH₂)ₙNH[AA₁]ₓ_{¹}-[AA₂]ₓ_{²}H

wherein the Init group is derived from an alkylamine and AA₁ and AA₂ represent block polymers of two different amino acids, the indices x¹+x²=x, and x is from about 10 to about 400. Non-limiting examples of this iteration includes:
CH₃(CH₂)₅NH-[(L-lysine)₁₈₀-b-(L-leucine)₂₀]-H;
CH₃(CH₂)₅NH-[(L-lysine)₁₆₀-b-(L-leucine)₄₀]-H;
CH₃(CH₂)₅NH-[(L-lysine)₁₈₀-b-(L-leucine)₄₀]-H;
CH₃(CH₂)₅NH-[(L-lysine)₁₀₀-b-(L-leucine)₄₀]-H;
CH₃(CH₂)₅NH-[(L-lysine)₉₀-b-(L-leucine)₁₀]-H;
CH₃(CH₂)₅NH-[(L-lysine)₈₀-b-(L-leucine)₂₀]-H;
CH₃(CH₂)₅NH-[(L-lysine)₇₀-b-(L-leucine)₃₀]-H;
CH₃(CH₂)₅NH-[(L-lysine)₆₀-b-(L-leucine)₄₀]-H;
CH₃(CH₂)₅NH-[(L-lysine)₅₀-b-(L-leucine)₅₀]-H;
CH₃(CH₂)₅NH-[(L-lysine)₄₀-b-(L-leucine)₆₀]-H;
CH₃(CH₂)₅NH-[(L-lysine)₃₀-b-(L-leucine)₇₀]-H;
CH₃(CH₂)₅NH-[(L-lysine)₂₀-b-(L-leucine)₈₀]-H;
CH₃(CH₂)₅NH-[(L-lysine)₁₀-b-(L-leucine)₉₀]-H;
CH₃(CH₂)₅NH-[(ω-Cbz-L-lysine)₁₈₀-b-(L-leucine)₂₀]-H;
CH₃(CH₂)₅NH-[(ω-Cbz-L-lysine)₁₆₀-b-(L-leucine)₄₀]-H;
CH₃(CH₂)₅NH-[(ω-Cbz-L-lysine)₁₈₀-b-(L-leucine)₄₀]-H;
CH₃(CH₂)₅NH-[(ω-Cbz-L-lysine)₁₀₀-b-(L-leucine)₄₀]-H;
CH₃(CH₂)₅NH-[(ω-Cbz-L-lysine)₉₀-b-(L-leucine)₁₀]-H;
CH₃(CH₂)₅NH-[(ω-Cbz-L-lysine)₈₀-b-(L-leucine)₂₀]-H;
CH₃(CH₂)₅NH-[(ω-Cbz-L-lysine)₇₀-b-(L-leucine)₃₀]-H;
CH₃(CH₂)₅NH-[(ω-Cbz-L-lysine)₆₀-b-(L-leucine)₄₀]-H;
CH₃(CH₂)₅NH-[(ω-Cbz-L-lysine)₅₀-b-(L-leucine)₅₀]-H;
CH₃(CH₂)₅NH-[(ω-Cbz-L-lysine)₄₀-b-(L-leucine)₆₀]-H;
CH₃(CH₂)₅NH-[(ω-Cbz-L-lysine)₃₀-b-(L-leucine)₇₀]-H;
CH₃(CH₂)₅NH-[(ω-Cbz-L-lysine)₂₀-b-(L-leucine)₈₀]-H;
CH₃(CH₂)₅NH-[(ω-Cbz-L-lysine)₁₀-b-(L-leucine)₉₀]-H;
CH₃(CH₂)₅NH-[(L-arginine)₁₈₀-b-(L-leucine)₂₀]-H;
CH₃(CH₂)₅NH-[(L-arginine)₁₆₀-b-(L-leucine)₄₀]-H;
CH₃(CH₂)₅NH-[(L-arginine)₁₈₀-b-(L-leucine)₄₀]-H;
CH₃(CH₂)₅NH-[(L-arginine)₁₀₀-b-(L-leucine)₄₀]-H;
CH₃(CH₂)₅NH-[(L-arginine)₉₀-b-(L-leucine)₁₀]-H;
CH₃(CH₂)₅NH-[(L-arginine)₈₀-b-(L-leucine)₂₀]-H;
CH₃(CH₂)₅NH-[(L-arginine)₇₀-b-(L-leucine)₃₀]-H;
CH₃(CH₂)₅NH-[(L-arginine)₆₀-b-(L-leucine)₄₀]-H;
CH₃(CH₂)₅NH-[(L-arginine)₅₀-b-(L-leucine)₅₀]-H;
CH₃(CH₂)₅NH-[(L-arginine)₄₀-b-(L-leucine)₆₀]-H;
CH₃(CH₂)₅NH-[(L-arginine)₃₀-b-(L-leucine)₇₀]-H;
CH₃(CH₂)₅NH-[(L-arginine)₂₀-b-(L-leucine)₈₀]-H;
CH₃(CH₂)₅NH-[(L-arginine)₁₀-b-(L-leucine)₉₀]-H;
CH₃(CH₂)₅NH-[(ω-di-Cbz-L-arginine)₁₈₀-b-(L-leucine)₂₀]-H;
CH₃(CH₂)₅NH-[(ω-di-Cbz-L-arginine)₁₆₀-b-(L-leucine)₄₀]-H;
CH₃(CH₂)₅NH-[(ω-di-Cbz-L-arginine)₁₈₀-b-(L-leucine)₄₀]-H;
CH₃(CH₂)₅NH-[(ω-di-Cbz-L-arginine)₁₀₀-b-(L-leucine)₄₀]-H;
CH₃(CH₂)₅NH-[(ω-di-Cbz-L-arginine)₉₀-b-(L-leucine)₁₀]-H;
CH₃(CH₂)₅NH-[(ω-di-Cbz-L-arginine)₈₀-b-(L-leucine)₂₀]-H;
CH₃(CH₂)₅NH-[(ω-di-Cbz-L-arginine)₇₀-b-(L-leucine)₃₀]-H;
CH₃(CH₂)₅NH-[(ω-di-Cbz-L-arginine)₆₀-b-(L-leucine)₄₀]-H;
CH₃(CH₂)₅NH-[(ω-di-Cbz-L-arginine)₅₀-b-(L-leucine)₅₀]-H;
CH₃(CH₂)₅NH-[(ω-di-Cbz-L-arginine)₄₀-b-(L-leucine)₆₀]-H;
CH₃(CH₂)₅NH-[(ω-di-Cbz-L-arginine)₃₀-b-(L-leucine)₇₀]-H;
CH₃(CH₂)₅NH-[(ω-di-Cbz-L-arginine)₂₀-b-(L-leucine)₈₀]-H;
CH₃(CH₂)₅NH-[(ω-di-Cbz-L-arginine)₁₀-b-(L-leucine)₉₀]-H;
CH₃(CH₂)₅NH-[(L-glutamic acid)₁₈₀-b-(L-leucine)₂₀]-H;
CH₃(CH₂)₅NH-[(L-glutamic acid)₁₆₀-b-(L-leucine)₁₂₀]-H;
CH₃(CH₂)₅NH-[(L-glutamic acid)₁₈₀-b-(L-leucine)₁₂₀]-H;
CH₃(CH₂)₅NH-[(L-glutamic acid)₁₀₀-b-(L-leucine)₁₀₀]-H;
CH₃(CH₂)₅NH-[(L-glutamic acid)₉₀-b-(L-leucine)₁₀]-H;
CH₃(CH₂)₅NH-[(L-glutamic acid)₈₀-b-(L-leucine)₂₀]-H;
CH₃(CH₂)₅NH-[(L-glutamic acid)₇₀-b-(L-leucine)₃₀]-H;
CH₃(CH₂)₅NH-[(L-glutamic acid)₆₀-b-(L-leucine)₄₀]-H;
CH₃(CH₂)₅NH-[(L-glutamic acid)₅₀-b-(L-leucine)₅₀]-H;
CH₃(CH₂)₅NH-[(L-glutamic acid)₄₀-b-(L-leucine)₆₀]-H;
CH₃(CH₂)₅NH-[(L-glutamic acid)₃₀-b-(L-leucine)₇₀]-H;
CH₃(CH₂)₅NH-[(L-glutamic acid)₂₀-b-(L-leucine)₈₀]-H;
CH₃(CH₂)₅NH-[(L-glutamic acid)₁₀-b-(L-leucine)₉₀]-H;
CH₃(CH₂)₅NH-[(ω-Bnz-L-glutamic acid)₁₈₀-b-(L-leucine)₂₀]-H;
CH₃(CH₂)₅NH-[(ω-Bnz-L-glutamic acid)₁₆₀-b-(L-leucine)₄₀]-H;
CH₃(CH₂)₅NH-[(ω-Bnz-L-glutamic acid)₁₈₀-b-(L-leucine)₄₀]-H;
CH₃(CH₂)₅NH-[(ω-Bnz-L-glutamic acid)₁₀₀-b-(L-leucine)₄₀]-H;
CH₃(CH₂)₅NH-[(ω-Bnz-L-glutamic acid)₉₀-b-(L-leucine)₁₀]-H;
CH₃(CH₂)₅NH-[(ω-Bnz-L-glutamic acid)₈₀-b-(L-leucine)₂₀]-H;
CH₃(CH₂)₅NH-[(ω-Bnz-L-glutamic acid)₇₀-b-(L-leucine)₃₀]-H;
CH₃(CH₂)₅NH-[(ω-Bnz-L-glutamic acid)₆₀-b-(L-leucine)₄₀]-H;
CH₃(CH₂)₅NH-[(ω-Bnz-L-glutamic acid)₅₀-b-(L-leucine)₅₀]-H;
CH₃(CH₂)₅NH-[(ω-Bnz-L-glutamic acid)₄₀-b-(L-leucine)₆₀]-H;
CH₃(CH₂)₅NH-[(ω-Bnz-L-glutamic acid)₃₀-b-(L-leucine)₇₀]-H;
CH₃(CH₂)₅NH-[(ω-Bnz-L-glutamic acid)₂₀-b-(L-leucine)₈₀]-H; and
CH₃(CH₂)₅NH-[(ω-Bnz-L-glutamic acid)₁₀-b-(L-leucine)₉₀]-H.

Another iteration of this embodiment relates to block copolymers having the formula:

MPEG(MW1,000-20,000)[AA₁]ₓ_{¹}-[AA₂]ₓ_{²}H

wherein the Init group is derived from an alkylamine and AA₁ and AA₂ represent block polymers of two different amino acids, the indices x¹+x²=x, and x is from about 10 to about 400. Non-limiting examples of this iteration includes:
MPEG(5000)-[(L-lysine)₁₈₀-b-(L-leucine)₂₀]-H;
MPEG(5000)-[(L-lysine)₁₆₀-b-(L-leucine)₁₂₀]-H;
MPEG(5000)-[(L-lysine)₁₈₀-b-(L-leucine)₁₂₀]-H;
MPEG(5000)-[(L-lysine)₁₀₀-b-(L-leucine)₁₀₀]-H;
MPEG(5000)-[(L-lysine)₉₀-b-(L-leucine)₁₀]-H;
MPEG(5000)-[(L-lysine)₈₀-b-(L-leucine)₂₀]-H;
MPEG(5000)-[(L-lysine)₇₀-b-(L-leucine)₃₀]-H;
MPEG(5000)-[(L-lysine)₆₀-b-(L-leucine)₄₀]-H;
MPEG(5000)-[(L-lysine)₅₀-b-(L-leucine)₅₀]-H;
MPEG(5000)-[(L-lysine)₄₀-b-(L-leucine)₆₀]-H;
MPEG(5000)-[(L-lysine)₃₀-b-(L-leucine)₇₀]-H;
MPEG(5000)-[(L-lysine)₂₀-b-(L-leucine)₈₀]-H;
MPEG(5000)-[(L-lysine)₁₀-(L-leucine)₉₀]-H;
MPEG(5000)-[(ω-Cbz-L-lysine)₁₈₀-b-(L-leucine)₂₀]-H;
MPEG(5000)-[(ω-Cbz-L-lysine)₁₆₀-b-(L-leucine)₁₂₀]-H;
MPEG(5000)-[(ω-Cbz-L-lysine)₁₈₀-b-(L-leucine)₁₂₀]-H;
MPEG(5000)-[(ω-Cbz-L-lysine)₁₀₀-b-(L-leucine)₁₀₀]-H;
MPEG(5000)-[(ω-Cbz-L-lysine)₉₀-b-(L-leucine)₁₀]-H;
MPEG(5000)-[(ω-Cbz-L-lysine)₈₀-b-(L-leucine)₂₀]-H;
MPEG(5000)-[(ω-Cbz-L-lysine)₇₀-b-(L-leucine)₃₀]-H;
MPEG(5000)-[(ω-Cbz-L-lysine)₆₀-b-(L-leucine)₄₀]-H;
MPEG(5000)-[(ω-Cbz-L-lysine)₅₀-b-(L-leucine)₅₀]-H;
MPEG(5000)-[(ω-Cbz-L-lysine)₄₀-b-(L-leucine)₆₀]-H;
MPEG(5000)-[(ω-Cbz-L-lysine)₃₀-b-(L-leucine)₇₀]-H;
MPEG(5000)-[(ω-Cbz-L-lysine)₂₀-b-(L-leucine)₈₀]-H;
MPEG(5000)-[(ω-Cbz-L-lysine)₁₀-b-(L-leucine)₉₀]-H;
MPEG(5000)-[(ω-TFA-L-lysine)₁₈₀-b-(L-leucine)₂₀]-H;
MPEG(5000)-[(ω-TFA-L-lysine)₁₆₀-b-(L-leucine)₁₂₀]-H;
MPEG(5000)-[(ω-TFA-L-lysine)₁₈₀-b-(L-leucine)₁₂₀]-H;
MPEG(5000)-[(ω-TFA-L-lysine)₁₀₀-b-(L-leucine)₁₀₀]-H;
MPEG(5000)-[(ω-TFA-L-lysine)₉₀-b-(L-leucine)₁₀]-H;
MPEG(5000)-[(ω-TFA-L-lysine)₈₀-b-(L-leucine)₂₀]-H;
MPEG(5000)-[(ω-TFA-L-lysine)₇₀-b-(L-leucine)₃₀]-H;
MPEG(5000)-[(ω-TFA-L-lysine)₆₀-b-(L-leucine)₄₀]-H;
MPEG(5000)-[(ω-TFA-L-lysine)₅₀-b-(L-leucine)₅₀]-H;
MPEG(5000)-[(ω-TFA-L-lysine)₄₀-b-(L-leucine)₆₀]-H;
MPEG(5000)-[(ω-TFA-L-lysine)₃₀-b-(L-leucine)₇₀]-H;
MPEG(5000)-[(ω-TFA-L-lysine)₂₀-b-(L-leucine)₈₀]-H;
MPEG(5000)-[(ω-TFA-L-lysine)₁₀-b-(L-leucine)₉₀]-H;
MPEG(5000)-[(L-arginine)₁₈₀-b-(L-leucine)₂₀]-H;
MPEG(5000)-[(L-arginine)₁₆₀-b-(L-leucine)₁₂₀]-H;
MPEG(5000)-[(L-arginine)₁₈₀-b-(L-leucine)₁₂₀]-H;
MPEG(5000)-[(L-arginine)₁₀₀-b-(L-leucine)₁₀₀]-H;
MPEG(5000)-[(L-arginine)₉₀-b-(L-leucine)₁₀]-H;
MPEG(5000)-[(L-arginine)₈₀-b-(L-leucine)₂₀]-H;
MPEG(5000)-[(L-arginine)₇₀-b-(L-leucine)₃₀]-H;
MPEG(5000)-[(L-arginine)₆₀-b-(L-leucine)₄₀]-H;
MPEG(5000)-[(L-arginine)₅₀-b-(L-leucine)₅₀]-H;
MPEG(5000)-[(L-arginine)₄₀-b-(L-leucine)₆₀]-H;
MPEG(5000)-[(L-arginine)₃₀-b-(L-leucine)₇₀]-H;
MPEG(5000)-[(L-arginine)₂₀-b-(L-leucine)₈₀]-H;
MPEG(5000)-[(L-arginine)₁₀-b-(L-leucine)₉₀]-H;
MPEG(5000)-[(ω-di-Cbz-L-arginine)₁₈₀-b-(L-leucine)₂₀]-H;
MPEG(5000)-[(ω-di-Cbz-L-arginine)₁₆₀-b-(L-leucine)₁₂₀]-H;
MPEG(5000)-[(ω-di-Cbz-L-arginine)₁₈₀-b-(L-leucine)₁₂₀]-H;
MPEG(5000)-[(ω-di-Cbz-L-arginine)₁₀₀-b-(L-leucine)₁₀₀]-H;
MPEG(5000)-[(ω-di-Cbz-L-arginine)₉₀-b-(L-leucine)₁₀]-H;
MPEG(5000)-[(ω-di-Cbz-L-arginine)₈₀-b-(L-leucine)₂₀]-H;
MPEG(5000)-[(ω-di-Cbz-L-arginine)₇₀-b-(L-leucine)₃₀]-H;
MPEG(5000)-[(ω-di-Cbz-L-arginine)₆₀-b-(L-leucine)₄₀]-H;
MPEG(5000)-[(ω-di-Cbz-L-arginine)₅₀-b-(L-leucine)₅₀]-H;
MPEG(5000)-[(ω-di-Cbz-L-arginine)₄₀-b-(L-leucine)₆₀]-H;
MPEG(5000)-[(ω-di-Cbz-L-arginine)₃₀-b-(L-leucine)₇₀]-H;
MPEG(5000)-[(ω-di-Cbz-L-arginine)₂₀-b-(L-leucine)₈₀]-H;
MPEG(5000)-[(ω-di-Cbz-L-arginine)₁₀-b-(L-leucine)₉₀]-H;
MPEG(5000)-[(L-glutamic acid)₁₈₀-b-(L-leucine)₂₀]-H;
MPEG(5000)-[(L-glutamic acid)₁₆₀-b-(L-leucine)₁₂₀]-H;
MPEG(5000)-[(L-glutamic acid)₁₈₀-b-(L-leucine)₁₂₀]-H;
MPEG(5000)-[(L-glutamic acid)₁₀₀-b-(L-leucine)₁₀₀]-H;
MPEG(5000)-[(L-glutamic acid)₉₀-b-(L-leucine)₁₀]-H;
MPEG(5000)-[(L-glutamic acid)₈₀-b-(L-leucine)₂₀]-H;
MPEG(5000)-[(glutamic acid)₇₀-b-(L-leucine)₃₀]-H;
MPEG(5000)-[(L-glutamic acid)₆₀-b-(L-leucine)₄₀]-H;
MPEG(5000)-[(L-glutamic acid)₅₀-b-(L-leucine)₅₀]-H;
MPEG(5000)-[(L-glutamic acid)₄₀-b-(L-leucine)₆₀]-H;
MPEG(5000)-[(L-glutamic acid)₃₀-b-(L-leucine)₇₀]-H;
MPEG(5000)-[(L-glutamic acid)₂₀-b-(L-leucine)₈₀]-H;
MPEG(5000)-[(L-glutamic acid)₁₀-b-(L-leucine)₉₀]-H;
MPEG(5000)-[(ω-Bnz-L-glutamic acid) l₈₀-b-(L-leucine)₂₀]-H;
MPEG(5000)-[(ω-Bnz-L-glutamic acid)₁₆₀-b-(L-leucine)₁₂₀]-H;
MPEG(5000)-[(ω-Bnz-L-glutamic acid)₁₈₀-b-(L-leucine)₁₂₀]-H;
MPEG(5000)-[(ω-Bnz-L-glutamic acid)₁₀₀-b-(L-leucine)₁₀₀]-H;
MPEG(5000)-[(ω-Bnz-L-glutamic acid)₉₀-b-(L-leucine)₁₀]-H;
MPEG(5000)-[(ω-Bnz-L-glutamic acid)₈₀-b-(L-leucine)₂₀]-H;
MPEG(5000)-[(ω-Bnz-L-glutamic acid)₇₀-b-(L-leucine)₃₀]-H;
MPEG(5000)-[(ω-Bnz-L-glutamic acid)₆₀-b-(L-leucine)₄₀]-H;
MPEG(5000)-[(ω-Bnz-L-glutamic acid)₅₀-b-(L-leucine)₅₀]-H;
MPEG(5000)-[(ω-Bnz-L-glutamic acid)₄₀-b-(L-leucine)₆₀]-H;
MPEG(5000)-[(ω-Bnz-L-glutamic acid)₃₀-b-(L-leucine)₇₀]-H;
MPEG(5000)-[(ω-Bnz-L-glutamic acid)₂₀-b-(L-leucine)₈₀]-H; and
MPEG(5000)-[(ω-Bnz-L-glutamic acid)₁₀-b-(L-leucine)₉₀]-H.

Another embodiment relates to block copolymers having the formula:

[Init][AA₁]ₓ_{¹}-[AA₂]ₓ_{²}-[AA₃]ₓ_{³}H

wherein the Init group is derived from an alkylamine and AA₁, AA₂, and AA₃ represent block polymers of two or more different amino acids.

One iteration of this embodiment relates to block copolymers having the formula:

R³(CH₂)ₙNH[AA₁]ₓ_{¹}-[AA₂]ₓ_{²}-[AA₃]ₓ_{³}H

non-limiting examples of which include:
CH₃(CH₂)₅NH-[(L-lysine)₁₈₀-b-(L-leucine)₂₀-b-(L-lysine)₁₈₀]-H;
CH₃(CH₂)₅NH-[(L-lysine)₁₆₀-b-(L-leucine)₂₀-b-(L-lysine)₁₆₀]-H;
CH₃(CH₂)₅NH-[(L-lysine)₁₄₀-b-(L-leucine)₂₀-b-(L-lysine)₁₄₀]-H;
CH₃(CH₂)₅NH-[(L-lysine)₁₂₀-b-(L-leucine)₂₀-b-(L-lysine)₁₂₀]-H;
CH₃(CH₂)₅NH-[(L-lysine)₁₀₀-b-(L-leucine)₂₀-b-(L-lysine)₁₀]-H;
CH₃(CH₂)₅NH-[(L-lysine)₉₀-b-(L-leucine)₂₀-b-(L-lysine)₉₀]-H;
CH₃(CH₂)₅NH-[(L-lysine)₈₀-b-(L-leucine)₂₀-b-(L-lysine)₈₀]-H;
CH₃(CH₂)₅NH-[(L-lysine)₇₀-b-(L-leucine)₂₀-b-(L-lysine)₇₀]-H;
CH₃(CH₂)₅NH-[(L-lysine)₆₀-b-(L-leucine)₂₀-b-(L-lysine)₆₀]-H;
CH₃(CH₂)₅NH-[(L-arginine)₁₈₀-b-(L-leucine)₂₀-b-(L-arginine) l₈₀]-H;
CH₃(CH₂)₅NH-[(L-arginine)₁₆₀-b-(L-leucine)₂₀-b-(L-arginine)₁₆₀]-H;
CH₃(CH₂)₅NH-[(L-arginine)₁₄₀-b-(L-leucine)₂₀-b-(L-arginine)₁₄₀]-H;
CH₃(CH₂)₅NH-[(L-arginine)₁₂₀-b-(L-leucine)₂₀-b-(L-arginine)₁₂₀]-H;
CH₃(CH₂)₅NH-[(L-arginine)₁₀₀-b-(L-leucine)₂₀-b-(L-arginine)₁₀₀]-H;
CH₃(CH₂)₅NH-[(L-arginine)₉₀-b-(L-leucine)₂₀-b-(L-arginine)₉₀]-H;
CH₃(CH₂)₅NH-[(L-arginine)₉₀-b-(L-leucine)₂₀-b-(L-arginine)₉₀]-H;
CH₃(CH₂)₅NH-[(L-arginine)₇₀-b-(L-leucine)₂₀-b-(L-arginine)₇₀]-H;
CH₃(CH₂)₅NH-[(L-arginine)₆₀-b-(L-leucine)₂₀-b-(L-arginine)₆₀]-H;
CH₃(CH₂)₅NH-[(L-glutamic acid)₁₈₀-b-(L-leucine)₂₀-b-(L-glutamic acid)₁₈₀]-H;
CH₃(CH₂)₅NH-[(L-glutamic acid)₁₆₀-b-(L-leucine)₂₀-b-(L-glutamic acid)₁₆₀]-H;
CH₃(CH₂)₅NH-[(L-glutamic acid)₁₄₀-b-(L-leucine)₂₀-b-(L-glutamic acid)₁₄₀]-H;
CH₃(CH₂)₅NH-[(L-glutamic acid)₁₂₀-b-(L-leucine)₂₀-b-(L-glutamic acid)₁₂₀]-H;
CH₃(CH₂)₅NH-[(L-glutamic acid)₁₀₀-b-(L-leucine)₂₀-b-(L-glutamic acid)₁₀₀]-H;
CH₃(CH₂)₅NH-[(L-glutamic acid)₉₀-b-(L-leucine)₂₀-b-(L-glutamic acid)₉₀]-H;
CH₃(CH₂)₅NH-[(L-glutamic acid)₈₀-b-(L-leucine)₂₀-b-(L-glutamic acid)₈₀]-H;
CH₃(CH₂)₅NH-[(L-glutamic acid)₇₀-b-(L-leucine)₂₀-b-(L-glutamic acid)₇₀]-H; and
CH₃(CH₂)₅NH-[(L-glutamic acid)₆₀-b-(L-leucine)₂₀-b-(L-glutamic acid)₆₀]-H.

Another iteration includes block copolymers having the formula:

MPEG(MW1,000-10,000)[AA₁]ₓ_{¹}-[AA₂]ₓ_{²}-[AA₃]ₓ_{³}H

non-limiting examples of which include:
MPEG(5000)-[(L-lysine)₁₈₀-b-(L-leucine)₂₀-b-(L-lysine)₁₈₀]-H;
MPEG(5000)-[(L-lysine)₁₆₀-b-(L-leucine)₂₀-b-(L-lysine)₁₆₀]-H;
MPEG(5000)-[(L-lysine)₁₄₀-b-(L-leucine)₂₀-b-(L-lysine)₁₄₀]-H;
MPEG(5000)-[(L-lysine)₁₂₀-b-(L-leucine)₂₀-b-(L-lysine)₁₂₀]-H;
MPEG(5000)-[(L-lysine)₁₈₀-b-(L-leucine)₂₀-b-(L-lysine)₁₈₀]-H;
MPEG(5000)-[(L-lysine)₁₈₀-b-(L-leucine)₂₀-b-(L-lysine)₁₈₀]-H;
MPEG(5000)-[(L-lysine)₉₀-b-(L-leucine)₂₀-b-(L-lysine)₉₀]-H; MPEG(5000)-[(L-lysine)₈₀-b-(L-leucine)₂₀-b-(L-lysine)₈₀]-H;
MPEG(5000)-[(L-lysine)₇₀-b-(L-leucine)₂₀-b-(L-lysine)₇₀]-H;
MPEG(5000)-[(L-lysine)₆₀-b-(L-leucine)₂₀-b-(L-lysine)₆₀]-H;
MPEG(5000)-[(L-glutamic acid)₁₈₀-b-(L-leucine)₂₀-b-(L-glutamic acid)₁₈₀]-H;
MPEG(5000)-[(L-glutamic acid)₁₆₀-b-(L-leucine)₂₀-b-(L-glutamic acid)₁₆₀]-H;
MPEG(5000)-[(L-glutamic acid)₁₄₀-b-(L-leucine)₂₀-b-(L-glutamic acid)₁₄₀]-H;
MPEG(5000)-[(L-glutamic acid)₁₂₀-b-(L-leucine)₂₀-b-(L-glutamic acid)₁₂₀]-H;
MPEG(5000)-[(L-glutamic acid)₁₈₀-b-(L-leucine)₂₀-b-(L-glutamic acid)₁₈₀]-H;
MPEG(5000)-[(L-glutamic acid)₁₈₀-b-(L-leucine)₂₀-b-(L-glutamic acid)₁₈₀]-H;
MPEG(5000)-[(L-glutamic acid)₉₀-b-(L-leucine)₂₀-b-(L-glutamic acid)₉₀]-H;
MPEG(5000)-[(L-glutamic acid)₈₀-b-(L-leucine)₂₀-b-(L-glutamic acid)₈₀]-H;
MPEG(5000)-[(L-glutamic acid)₇₀-b-(L-leucine)₂₀-b-(L-glutamic acid)₇₀]-H; and
MPEG(5000)-[(L-glutamic acid)₆₀-b-(L-leucine)₂₀-b-(L-glutamic acid)₆₀]-H.

A yet further category of the disclosed polymers relates to polymers having the formula:

(R^{a})ₘ[AA]ₓ-[Init]-[AA]_{y}-(R^{b})ₙ

wherein Init is an unit derived from a polymerization initiator, each AA is a homopolymer of an amino acid or a homopolymer of a protected amino acid, R^{b} is hydrogen, a protecting group, or a unit that is capable of further reacting the polymer with one or more substrates, the index x is from about 10 to about 40, the index y is from about 10 to about 40.

Non-limiting examples of this category include:
H-[(L-lysine)₂₀₀-PEG(5000)-(L-lysine)₂₀₀]-H;
H-[(L-lysine)₁₆₀-PEG(5000)-(L-lysine)₁₆₀]-H;
H-[(L-lysine)₁₂₀-PEG(5000)-(L-lysine)₁₂₀]-H;
H-[(L-lysine)₁₀₀-PEG(5000)-(L-lysine)₁₀₀]-H;
H-[(L-lysine)₈₀-PEG(5000)-(L-lysine)₈₀]-H;
H-[(L-lysine)₇₀-PEG(5000)-(L-lysine)₇₀]-H;
H-[(L-lysine)₆₀-PEG(5000)-(L-lysine)₆₀]-H;
H-[(L-lysine)₅₀-PEG(5000)-(L-lysine)₅₀]-H;
H-[(L-lysine)₄₀-PEG(5000)-(L-lysine)₄₀]-H;
H-[(L-lysine)₃₀-PEG(5000)-(L-lysine)₃₀]-H;
H-[(L-lysine)₂₀-PEG(5000)-(L-lysine)₂₀]-H;
H-[(L-lysine)₁₀-PEG(5000)-(L-lysine)₁₀]-H;
H-[(ω-Cbz-L-lysine)₂₀₀-PEG(5000)-(ω-Cbz-L-lysine)₂₀₀]-H;
H-[(ω-Cbz-L-lysine)₁₆₀-PEG(5000)-(ω-Cbz-L-lysine)₁₆₀]-H;
H-[(ω-Cbz-L-lysine)₁₂₀-PEG(5000)-(ω-Cbz-L-lysine)₁₂₀]-H;
H-[(ω-Cbz-L-lysine)₁₀₀-PEG(5000)-(ω-Cbz-L-lysine)₁₀₀]-H;
H-[(ω-Cbz-L-lysine)₈₀-PEG(5000)-(ω-Cbz-L-lysine)₈₀]-H;
H-[(ω-Cbz-L-lysine)₇₀-PEG(5000)-(ω-Cbz-L-lysine)₇₀]-H;
H-[(ω-Cbz-L-lysine)₆₀-PEG(5000)-(ω-Cbz-L-lysine)₆₀]-H;
H-[(ω-Cbz-L-lysine)₅₀-PEG(5000)-(ω-Cbz-L-lysine)₅₀]-H;
H-[(ω-Cbz-L-lysine)₄₀-PEG(5000)-(ω-Cbz-L-lysine)₄₀]-H;
H-[(ω-Cbz-L-lysine)₃₀-PEG(5000)-(ω-Cbz-L-lysine)₃₀]-H;
H-[(ω-Cbz-L-lysine)₂₀-PEG(5000)-(ω-Cbz-L-lysine)₂₀]-H;
H-[(ω-Cbz-L-lysine)₁₀-PEG(5000)-(ω-Cbz-L-lysine)₁₀]-H;
H-[(L-arginine)₂₀₀-PEG(5000)-(L-arginine)₂₀₀]-H;
H-[(L-arginine)₁₆₀-PEG(5000)-(L-arginine)₁₆₀]-H;
H-[(L-arginine)₁₂₀-PEG(5000)-(L-arginine)₁₂₀]-H;
H-[(L-arginine)₁₀₀-PEG(5000)-(L-arginine)₁₀₀]-H;
H-[(L-arginine)₈₀-PEG(5000)-(L-arginine)₈₀]-H;
H-[(L-arginine)₇₀-PEG(5000)-(L-arginine)₇₀]-H;
H-[(L-arginine)₆₀-PEG(5000)-(L-arginine)₆₀]-H;
H-[(L-arginine)₅₀-PEG(5000)-(L-arginine)₅₀]-H;
H-[(L-arginine)₄₀-PEG(5000)-(L-arginine)₄₀]-H;
H-[(L-arginine)₃₀-PEG(5000)-(L-arginine)₃₀]-H;
H-[(L-arginine)₂₀-PEG(5000)-(L-arginine)₂₀]-H;
H-[(L-arginine)₁₀-PEG(5000)-(L-arginine)₁₀]-H;
H-[(ω-di-Cbz-L-arginine)₂₀₀-PEG(5000)-(ω-di-Cbz-L-arginine)₂₀₀]-H;
H-[(ω-di-Cbz-L-arginine)₁₆₀-PEG(5000)-(ω-di-Cbz-L-arginine)₁₆₀]-H;
H-[(ω-di-Cbz-L-arginine)₁₂₀-PEG(5000)-(ω-di-Cbz-L-arginine)₁₂₀]-H;
H-[(ω-di-Cbz-L-arginine)₁₀₀-PEG(5000)-(ω-di-Cbz-L-arginine)₁₀₀]-H;
H-[(ω-di-Cbz-L-arginine)₈₀-PEG(5000)-(ω-di-Cbz-L-arginine)₈₀]-H;
H-[(ω-di-Cbz-L-arginine)₇₀-PEG(5000)-(ω-di-Cbz-L-arginine)₇₀]-H;
H-[(ω-di-Cbz-L-arginine)₆₀-PEG(5000)-(ω-di-Cbz-L-arginine)₆₀]-H;
H-[(ω-di-Cbz-L-arginine)₅₀-PEG(5000)-(ω-di-Cbz-L-arginine)₅₀]-H;
H-[(ω-di-Cbz-L-arginine)₄₀-PEG(5000)-(ω-di-Cbz-L-arginine)₄₀]-H;
H-[(ω-di-Cbz-L-arginine)₃₀-PEG(5000)-(ω-di-Cbz-L-arginine)₃₀]-H;
H-[(ω-di-Cbz-L-arginine)₂₀-PEG(5000)-(ω-di-Cbz-L-arginine)₂₀]-H; and
H-[(ω-di-Cbz-L-arginine)₁₀-PEG(5000)-(ω-di-Cbz-L-arginine)₁₀]-H.

### Process

The disclosed polymers can be prepared by a process that is entirely free from the use of metal catalysts and thus the disclosed polymers do not comprise any residual metal contamination. One process for preparing the disclosed polymers, comprises:
a) providing a source of one or more amino acid N-carboxyanhydrides, protected amino acid N-carboxyanhydrides, or mixtures thereof,
b) combining the source from step (a) with a hydrogen bond inhibitor to form an admixture;
c) combining the admixture from step (b) with an initiator; and
d) forming an amino acid polymer.

A further embodiment of the disclosed processes relates to a process for preparing a polymer having the formula:

[Init][AA₁]ₓ_{¹}-[AA₁]ₓ_{²}H

wherein AA₁ represents a first protected or unprotected amino acid, AA₂ represents a second protected or unprotected amino acid, x¹ represents the mole fraction of the first protected or unprotected amino acid, x² represents the mole fraction of the second protected or unprotected amino acid, and x¹+x=x², x is from about 10 to about 400, comprising:
a) providing a source of one or more amino acid N-carboxyanhydrides, protected amino acid N-carboxyanhydrides, or mixtures thereof in a solvent;
b) combining the source from step (a) with a hydrogen bond inhibitor chosen from thiorurea, urea, or guanidine, or a salt thereof, to form an admixture;
c) combining the admixture from step (b) with an initiator chosen from a primary amine or a polyalkylene glycol amine; and
d) forming an amino acid polymer.

Another embodiment of the disclosed processes relates to a process for preparing a homopolymer having the formula:

[Init]-[AA]ₓ-(R^{b})ₙ

wherein AA represents a protected or unprotected amino acid, R^{b} is hydrogen or a protecting group, x is from about 10 to about 400, comprising:
a) providing a source of an amino acid N-carboxyanhydride or a protected amino acid N-carboxyanhydride;
b) combining the source from step (a) with a hydrogen bond inhibitor to form an admixture;
c) combining the admixture from step (b) with an initiator; and
d) forming an amino acid homopolymer.

A further iteration of this embodiment comprises:
a) providing a source of an amino acid N-carboxyanhydride or a protected amino acid N-carboxyanhydride;
b) combining the source from step (a) with a hydrogen bond inhibitor chosen from thiorurea, urea, or guanidine, or a salt thereof, to form an admixture;
c) combining the admixture from step (b) with an initiator chosen from a primary amine or a polyalkylene glycol amine; and
d) forming an amino acid homopolymer.

In one iteration wherein R^{b} comprises an N¹-protecting group and the AA unit comprises an amino acid without a protecting group, comprises:
a) providing a source of an amino acid N-carboxyanhydride;
b) combining the source from step (a) with a hydrogen bond inhibitor to form an admixture;
c) combining the admixture from step (b) with an initiator;
d) forming an amino acid homopolymer;
e) providing a source of an N¹-protected activated amino acid;
f) combining the homopolymer formed in step (d) with the amino acid provided in step (e) to form a homopolymer wherein the N-terminal end of the homopolymer is truncated with an amino acid comprising a protecting group.

The following is a non-limiting example of homopolymers truncated with an R^{b} unit that is N¹-protected.

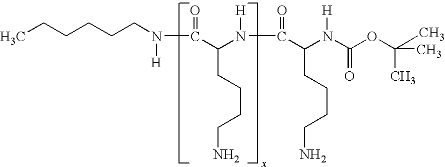

wherein the index x is from about 10 to about 400.

Likewise the AA homopolymer, as well as the truncating amino acid residue can also comprise a side-chain protecting group, for example:

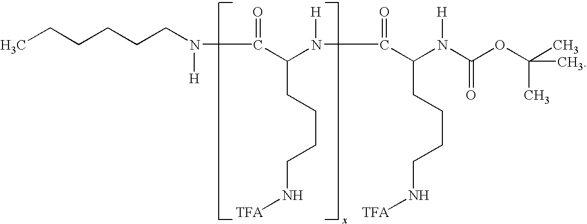

### Initiators

The following are non-limiting examples of polymerization initiators suitable for use in forming the disclosed polymers.

Amino Acids

Amino acids can be used as the initiators for the disclosed processes. The amino acid used as the initiator can be the same or different as the amino acids that comprise the balance of the polymer. In addition, bi-functional amino acids, inter alia, lysine, ornithine, aminothiols, and the like can be used to initiate a polymer chain that propagates in two directions. The amino acids used as initiators can be protected or unprotected amino acids.

Polyalkylene Glycol Comprising Units

One aspect of the disclosed polymers includes processes that encompass the use of polyalkyleneoxy comprising units. One embodiment of the polyalkyleneoxy comprising units suitable for use includes linear polymers and copolymers, non-limiting examples of which include homogeneous backbone polyalkylene glycols having the formula:

H[O(CR^{1a}R^{1b})ₙ]ₘOH;

heterogeneous backbone polyalkylene glycols having the formula:

H[O(CR^{1a}R^{1b})ₙ]ₘ[O(CR^{2a}R^{2b})ⱼ]ₖOH;

homogeneous backbone alkoxy polyalkylene glycols having the formula:

R³[O(CR^{1a}R^{1b})ₙ]ₘOH;

heterogeneous backbone alkoxy polyalkylene glycols having the formula:

R³[O(CR^{1a}R^{1b})ₙ]ₘ[O(CR^{2a}R^{2b})ⱼ]ₖOH;

homogeneous backbone polyalkylene glycol amines having the formula:

H[O(CR^{1a}R^{1b})ₙ]ₘNH₂;

heterogeneous backbone polyalkylene glycol amines having the formula:

H[O(CR^{1a}R^{1b})ₙ]ₘ[O(CR^{2a}R^{2b})ⱼ]ₖNH₂;

homogeneous backbone alkoxy polyalkylene glycol amines having the formula:

R³[O(CR^{1a}R^{1b})ₙ]ₘNH₂;

homogeneous backbone alkoxy polyalkylene glycol diamines having the formula:

H₂NCR^{1a}R^{1b}[O(CR^{1a}R^{1b})ₙ]ₘNH₂;

heterogeneous backbone alkoxy polyalkylene glycol amines having the formula:

R³[O(CR^{1a}R^{1b})ₙ]ₘ[O(CR^{2a}R^{2b})ⱼ]ₖNH₂;

wherein each R^{1a} and R^{1b} is independently chosen from hydrogen and C₁-C₂ alkyl; R^{2a} and R^{2b} is independently chosen from hydrogen and C₁-C₂ alkyl; R³ is C₁-C₄ linear alkyl; the index n is from 2 to 6, the index j is from 3 to 6, the indices m and k are each independently from 1 to 100; provided the index n and the index j are not the same.

A first embodiment of the polyalkylene glycols suitable for use in the disclosed processes relates to polyethylene glycol amines having the formula:

H[O(CH₂)₂]ₘNH₂;

wherein the index m is such that the polyalkylene glycol amine has an average molecular weight from about 500 g/mol to about 50,000 g/mol. In one iteration, the polyethylene glycol amine has an average molecular weight of about 5,000 g/mole. In another iteration, the polyethylene glycol amine has an average molecular weight of about 4,000 g/mole. In as further iteration, the polyethylene glycol amine has an average molecular weight of about 20,000 g/mole.

Because the disclosed processes provide for polymers having a low polydispersity, selection of polyethylene glycol amines which also have a low polydispersity provides for final products having a lower M_{w}/Mₙ value.

A further embodiment of the polyalkylene glycols suitable for use in the disclosed processes relates to alkoxy polyalkylene glycol amines having the formula:

R³[O(CH₂)₂]ₘNH₂;

wherein R³ is C₁-C₄ linear alkyl, the index m is such that the polyalkylene glycol amine has an average molecular weight from about 500 g/mol to about 50,000 g/mol. In one iteration, the alkoxy polyethylene glycol amine has an average molecular weight of about 5,000 g/mole. In another iteration, the alkoxy polyethylene glycol amine has an average molecular weight of about 4,000 g/mole. In as further iteration, the alkoxy polyethylene glycol amine has an average molecular weight of about 20,000 g/mole.

One example of an alkoxy polyethylene glycol amine are the methoxy polyethylene glycol amines having the formula:

CH₃[O(CH₂)₂]ₘNH₂;

wherein the average molecular weight is from about 500 g/mol to about 50,000 g/mol.

A further iteration includes polyalkylene glycol amines having mixed alkylene backbones, for example the amines having the formula:

H[OCH₂CH₂]ₘ[OCH(CH₃)CH₂]ₖNH₂;

wherein the average molecular weight is from about 500 g/mol to about 50,000 g/mol.

A still further iteration includes alkoxy polyalkylene glycol amines having mixed alkylene backbones, for example the amines having the formula:

CH₃[OCH₂CH₂]ₘ[OCH(CH₃)CH₂]ₖNH₂;

wherein the average molecular weight is from about 500 g/mol to about 50,000 g/mol.

A further iteration includes polyalkyleneoxy thiols, for example, thiols having the formula:

H[O(CR^{1a}R^{1b})ₙ]ₘSH;

polyalkyleneoxy thiols having the formula:

H[O(CR^{1a}R^{1b})ₙ]ₘ[O(CR^{1a}R^{1b})ⱼ]ₖSH;

polyalkyleneoxy dithiols having the formula:

HSCR^{1a}R^{1b}[O(CR^{1a}R^{1b})ₙ]ₘSH;

heterogeneous backbone polyalkyleneoxy dithiols having the formula:

HSCR^{1a}R^{1b}[O(CR^{1a}R^{1b})ₙ]ₘ[O(CR^{2a}R^{2b})ⱼ]ₖSH;

homogeneous backbone alkoxy polyalkyleneoxy thiols having the formula:

R³[O(CR^{1a}R^{1b})ₙ]ₘSH;

heterogeneous backbone alkoxy polyalkyleneoxy thiols having the formula:

R³[O(CR^{1a}R^{1b})ₙ]ₘ[O(CR^{2a}R^{2b})ⱼ]ₖSH;

A further embodiment of the polyalkyleneoxy comprising units include multi-arm units, for example, units having the formula:

i) C[CH₂[O(CR^{3a}R^{3b})ₚ]_{q}OH]₄;

ii) C[CH₂[O(CR^{3a}R^{3b})ₚ]_{q}NH₂]₄; and

iii) C[CH₂[O(CR^{3a}R^{3b})ₚ]_{q}SH]₄;

wherein each R^{3a} and R^{3b} is independently chosen from hydrogen and C₁-C₂ alkyl; the index p is from 2 to 6, the index q is from 1 to 100.

Amines and Polyamines

Another aspect of the polymerization initiators suitable for use in the disclosed processes includes amines and polyamines. The first embodiment of this aspect relates to linear, branched, and cyclic mono-amines, for example, methylamine, ethylamine, n-propylamine, iso-propylamine, butylamine, pentylamine, hexylamine, heptylamine, octylamine, nonylamine, decylamine, undecylamine, dodecylamine, tridecylamine, tetradecylamine, and the like. Further amines include cyclopropylamine, cyclobutylamine, cyclopentyl amine, cyclohexylamine, and the like.

Another embodiment relates to diamines having the formula:

H₂N(CR^{4a}R^{4b})ᵣNH₂

wherein R^{4a} and R^{4b} are each independently hydrogen or C₁-C₄ alkyl, and the index r is from 2 to about 20. Non-limiting examples include ethylene diamine, propylene diamine, tetramethylene diamine (butyleneamine), and hexamethylene diamine.

Diamines can further include cyclic diamines, inter alia, 1,3-diaminocyclobutane, 1,3-diaminocyclopentane, 1,3-diaminocyclohexane, 1,4-diaminocyclohexane and the like.

A further embodiment of the polymerization initiators suitable for use in the disclosed processed includes polyalkyleneimines (PAI's). One iteration of this embodiment includes polyethyleneimines (PEI's) having the formula:

H₂NCH₂CH₂]_{y+1}—[NHCH₂CH₂]_{z}—[NBCH₂CH₂]_{y}—NH₂

wherein the index y is from 1 to 12, z is from 0 to 20, and B is a continuation of the chain by branching. A non-liming example of a suitable PEI includes PEI-189 having the formula:

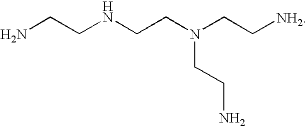

Other suitable PEI's include PEI-600, PEI-1200, and PEI-1800.

Amine-Comprising Polymers

A further aspect of the disclosed initiators includes monomers, dimers, trimers, tetramers, and the like of amine-comprising polymers. Non-limiting examples include vinyl amine, oligomers, and polymers thereof. Other polymers include poly(dimethylsiloxane) amines, poly(styrene) amines, poly(lactic acid) amines, aminated poly (lactones), aminated poly(oxazolines), aminated poly(lactams), aminated saccharides, and the like.

Hydrogen Bond Inhibitors

The hydrogen bond inhibitors of the disclosed process prevent the formation of secondary protein structure, for example, folding or formation β-pleated sheets. Because the disclosed processes inhibit the formation of β-pleated sheets, the growing amino acid chain remains solubilized and flexible and less polydisperse polymers can form. In addition, the inhibitors are further capable of limiting the amount of α-helices formed by the amino acid polymers. One example of hydrogen bond inhibitors relates to the use of thiourea.

Another example of a hydrogen bond inhibitor relates to the use of urea.

A further example includes guanidine and salts thereof. The following are non-limiting examples of anions that can form acceptable salts with guanidine: chloride, bromide, iodide, sulfate, bisulfate, carbonate, bicarbonate, phosphate, formate, acetate, propionate, butyrate, pyruvate, lactate, oxalate, malonate, maleate, succinate, tartrate, fumarate, citrate, and the like.

Another further example includes alkyl or aryl guanidinium salts having the formula:

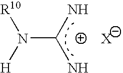

wherein R¹⁰ is substituted or unsubstituted alkyl or aryl, X is an anion providing electronic neutrality. The following are non-limiting examples of anions that can form acceptable salts with alkyl and aryl guanidine: chloride, bromide, iodide, sulfate, bisulfate, carbonate, bicarbonate, phosphate, formate, acetate, propionate, butyrate, pyruvate, lactate, oxalate, malonate, maleate, succinate, tartrate, fumarate, citrate, and the like.

Non-limiting embodiments of the disclosed processes as it relates to the preparation of the disclosed processes, includes the following example of a process for preparing a homopolymer of lysine. One iteration of this embodiment comprises:
a) providing a source of N^{ε}-protected lysin N-carboxyanhydride e in a solvent;
b) combining the source of N^{ε}-protected lysine N-carboxyanhydride with a hydrogen bond inhibitor to form an admixture;
c) combining the admixture from step (b) with an initiator;
d) forming poly(N^{ε}-protected lysine); and
e) removing the protecting group to form polylysine.

A non-limiting example of this iteration includes a process comprising:
a) providing a source of N^{ε}-(trifluoroacetyl)-L-lysine N-carboxyanhydride in N,N-dimethylformamide;
b) combining the source of N^{ε}-(trifluoroacetyl)-L-lysine N-carboxyanhydride with thiourea to form an admixture;
c) combining the admixture from step (b) with hexylamine;
d) forming poly(N^{ε}-(trifluoroacetyl)-L-lysine); and
e) removing the protecting group to form poly-L-lysine.

A further non-limiting example of this iteration includes a process comprising:
a) providing a source of N^{ε}-(trifluoroacetyl)-L-lysine N-carboxyanhydride in N,N-dimethylformamide;
b) combining the source of N^{ε}-(trifluoroacetyl)-L-lysine N-carboxyanhydride with thiourea to form an admixture;
c) combining the admixture from step (b) with a polyethylene glycol amine;
d) forming PEG-poly(N^{ε}-(trifluoroacetyl)-L-lysine); and
e) removing the protecting group to form poly-L-lysine.

Another non-limiting example of this iteration includes a process comprising:
a) providing a source of N^{ε}-(trifluoroacetyl)-L-lysine N-carboxyanhydride in N,N-dimethylformamide;
b) combining the source of N^{ε}-(trifluoroacetyl)-L-lysine N-carboxyanhydride with urea to form an admixture;
c) combining the admixture from step (b) with hexylamine;
d) forming poly(N^{ε}-(trifluoroacetyl)-L-lysine); and
e) removing the protecting group to form poly-L-lysine.

A still further non-limiting example of this iteration includes a process comprising:
a) providing a source of N^{ε}-(trifluoroacetyl)-L-lysine N-carboxyanhydride in N,N-dimethylformamide;
b) combining the source of N^{ε}-(trifluoroacetyl)-L-lysine N-carboxyanhydride with urea to form an admixture;
c) combining the admixture from step (b) with a polyethylene glycol amine;
d) forming PEG-poly(N^{ε}-(trifluoroacetyl)-L-lysine); and
e) removing the protecting group to form poly-L-lysine.

Another non-limiting embodiment of the present process for preparing homopolymers of amino acids, comprises:
a) providing a source of leucine N-carboxyanhydride in a solvent;
b) combining the source of leucine N-carboxyanhydride with a hydrogen bond inhibitor to form an admixture;
c) combining the admixture from step (b) with an initiator; and
d) forming polyleucine.

Example 5 herein below provides a non-limiting example of the preparation of an amino acid homopolymer according to the present disclosure.

Further embodiments of the disclosed processes include:
a) providing a source of a first amino acid N-carboxyanhydride or a first protected amino acid N-carboxyanhydride and a second amino acid N-carboxyanhydride or a second protected amino acid N-carboxyanhydride in a solvent;
b) combining the source of the first amino acid N-carboxyanhydride or a first protected amino acid N-carboxyanhydride and a second amino acid N-carboxyanhydride or a second protected amino N-carboxyanhydride with a hydrogen bond inhibitor to form an admixture;
c) combining the admixture from step (b) with an initiator; and
d) forming a copolymer.

A non-limiting example further includes:
a) providing a source of N-protected lysine N-carboxyanhydride and leucine N-carboxyanhydride in a solvent;
b) combining the source of N-protected lysine N-carboxyanhydride and leucine N-carboxyanhydride with a hydrogen bond inhibitor to form an admixture;
c) combining the admixture from step (b) with an initiator;
d) forming poly(N^{ε}-protected lysine); and
e) removing the protecting group to form poly(lysine)-co-(leucine).

Another non-limiting example of this iteration includes a process comprising:
a) providing a source of N^{ε}-(trifluoroacetyl)-L-lysine N-carboxyanhydride and L-leucine N-carboxyanhydride in N,N-dimethylformamide;
b) combining the source of N^{ε}-(trifluoroacetyl)-L-lysine N-carboxyanhydride and L-leucine N-carboxyanhydride with thiourea to form an admixture;
c) combining the admixture from step (b) with hexylamine;
d) forming poly(N^{ε}-(trifluoroacetyl)-L-lysine)-co-(L-leucine); and
e) removing the protecting group to form poly(L-lysine)-co-(L-leucine).

Grafted Polymers and Copolymers

The disclosed processes further relate to the formation of grafted polymers and copolymers. Grafted polymers can be derived from homopolymers or co-polymers containing reactive side chains that are protected during the formation of the initial polymer chain, subsequently deprotected, then further reacted with one or more amino acids or protected amino acids.

To illustrate this embodiment, the following depicts a segment of a poly(lysine)-co-(alanine) polymer wherein the N′-trifluoroacetyl protecting groups are still present on the lysine residues.

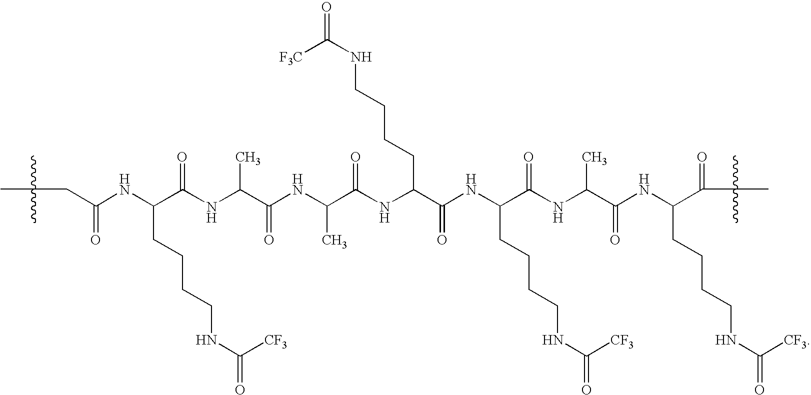

In a subsequent step, the protecting groups are removed to afford a copolymer wherein the reactive amino groups of the lysine side chains are now available for further reaction.

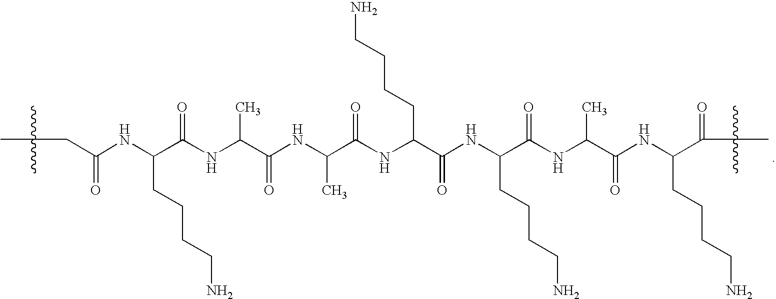

The following depicts the further grafting of alanine residues to the lysine side chains using a limited amount of alanine N-carboxyanhydride.

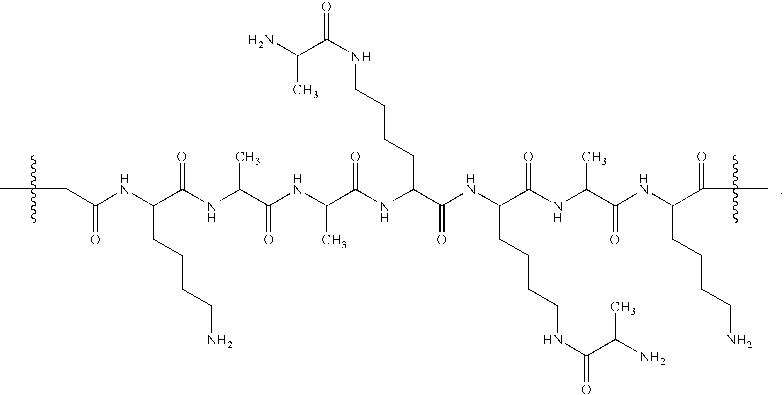

This process can encompass the use of other protected side chain moieties, for example, the acid moieties of aspartic acid and glutamic acid.

### Process Steps

The disclosed processes are conducted at low temperature, for example, in the range of from about −30° C. to about 30° C., and in several embodiments at or below 15° C. and in other embodiments at or below 10° C., while in still other embodiments at or below about 0° C. In addition, the disclosed processes does not utilize reagents comprising a heavy metal, for example, a metal from Groups 111B, IVB, VB, VIIB, VIIB, VII, IB, or IIB or lanthanides or actinides. The disclosed process is void of catalysts or initiators that comprise nickel (Ni) or copper (Cu). In addition, the steps of the disclosed process can be conducted sequentially, in one or more different orders, or one or more steps can be combined as further described herein below. In addition, further steps can be added to the present process. The disclosed process can be carried out using any modifications that are common to the formulator, for example, order of addition, reaction time, choice of solvent or combination of solvents, selection of amino acid protecting group, and the like.

Step (a)

Step (a) is providing a source of one or more amino acid NCA's, protected amino acid NCA's, or mixtures thereof. The source of amino acids can be from any commercial source or the amino acids or protected amino acids can be freshly prepared. The amount of amino acid that is provided will depend upon the length of the desired chain and/or the desired composition. For example, the length of homopolymers of amino acids can be controlled by the amount to initiator present in the reaction. Using an increase in the stoichiometric amount of initiator will increase the number of individual polymer chains being formed and therefore shorter chains will be able to be formed by a fixed amount of a source of amino acid. Because the disclosed process allows the formation of polymers having a lower polydispersity, the formulator can accurately determine the amount of amino acid and initiator to use to obtain a given polymer chain length.

An example of this embodiment of step (a) includes:
a) providing a source of one or more amino acid N-carboxyanhydrides, protected amino acid N-carboxyanhydrides, or mixtures thereof.

In one embodiment, wherein copolymers are to be formed, block copolymers can be obtained by providing the amino acid N-carboxyanhydrides or protected amino acid N-carboxyanhydrides separately. For example, the formulator chooses to prepare a co-polymer having a particular number of lysine residues in the polymer followed by a particular number of leucine residues, would provide the amino acids or protected amino acids separately according to the following process:
a) providing a source of a first amino acid N-carboxyanhydride or a first protected amino acid N-carboxyanhydride in a solvent;
b) combining the source of the first amino acid N-carboxyanhydride or a first protected amino acid N-carboxyanhydride with a hydrogen bond inhibitor to form an admixture;
c) combining the admixture from step (b) with an initiator;
d) forming a solution of a homopolymer segment comprising the first amino acid or the first protected amino acid;
e) providing a source of a second amino acid or a second protected amino acid in a solvent;

f) combining the source of a second amino acid or a second protected amino acid with the solution of the homopolymer segment; and

g) forming a poly(first amino acid/protected amino acid)-b-(second amino acid/protected amino acid) polymer.

The source of one or more amino acid N-carboxyanhydrides, protected amino acid N-carboxyanhydrides, or mixtures thereof can be provided in one or more solvents. Non-limiting examples of solvents include pentane, iso-pentane, hexane, heptane, octane, isooctane. benzene, nitro-benzene, toluene, and xylene dichloromethane, chloroform, carbon tetrachloride, 1,1-dichloroethane, 1,2-dichloroethane, 1,1,1-trichloroethane, acetone, methyl ethyl ketone, 3-pentanone, nitromethane, tetrahydrofuran, acetonitrile, dioxane, N-methyl-2-pyrrolidone, dimethyl sulfoxide, N,N-dimethylformamide, N,N-dimethylacetamide, and hexamethylphosphoric triamide.

In one embodiment N,N-dimethylformamide is used as a solvent for providing the one or more amino acid N-carboxyanhydrides, protected amino acid N-carboxyanhydrides, or mixtures thereof.

Step (b)

Step (b) relates to combining the source from step (a) with a hydrogen bond inhibitor to form an admixture. The hydrogen bond inhibitors can be any compound that inhibits the formation of a peptide secondary structure, for example, coiling of a peptide into an α-helix. Non-limiting examples of hydrogen bond inhibitors are described herein above. A first embodiment of hydrogen bond inhibitors relates to thiourea, while another embodiment relates to urea, while a further embodiment relates to guanidine or a guanidine salt as described herein above.

As an iteration to the disclosed process, steps (a) and (b) can be conducted as follows:
a) providing a hydrogen bond inhibitor; to form an admixture;
b) combining the hydrogen bond inhibitor with a source of one or more amino acid N-carboxyanhydrides, protected amino acid N-carboxyanhydrides, or mixtures thereof to form an admixture.

In variations of the disclosed process, the steps (a) and (b) can be combined as follows:
a) providing a source of an amino acid N-carboxyanhydrides or protected amino acid N-carboxyanhydrides and a hydrogen bond inhibitor.

Alternatively these combined steps can comprise:
a) providing a source of an amino acid N-carboxyanhydrides or protected amino acid N-carboxyanhydrides and a hydrogen bond inhibitor in a solvent.

Step (c)

Step (c) relates to combining the admixture from step (b) with an initiator, or

alternatively, with the following alternate steps (a) and (b) as follows:
a) providing a hydrogen bond inhibitor; to form an admixture;
b) combining the hydrogen bond inhibitor with a source of one or more amino acid N-carboxyanhydrides, protected amino acid N-carboxyanhydrides, or mixtures thereof to form an admixture;
c) combining the admixture from step (b) with an initiator.

The initiator can be any material which starts the polymerization process. One embodiment of the disclose process utilizes primary alkyl amines as an initiator, non-limiting examples of which include methylamine, ethylamine, propylamine, butylamine, n-pentylamine, n-hexylamine. Because the disclosed processes can be conducted at temperatures as low as about −30° C. (243 K), the use of low molecular weight amines is not precluded.

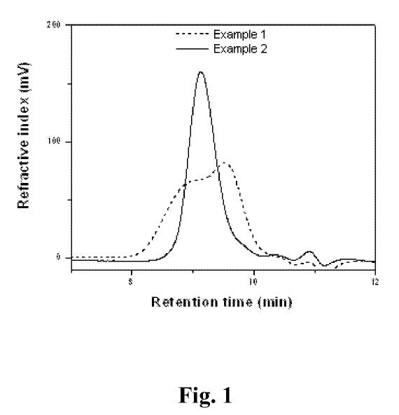

In another embodiment, a polyalkylene glycol amine, as described herein above, can be used as an initiator, as well as a component of the block copolymers. Adjustment in the ratio of initiator to N-carboxyanhydride will determine the length of the resulting polymer. As depicted in FIG. 1, a narrow range of polymers are provided by the disclosed process.

Step (d)

Step (d) relates to forming an amino acid comprising polymer as disclosed herein.

Step (d) can be carried out at any temperature from −30° C. to about 30° C. In one embodiment, the temperature is from about 0° C. to about 30° C. In another embodiment, the temperature is from about 15° C. to about 30° C. In a further embodiment, the temperature is from about −15° C. to about 0° C. In yet a further embodiment, the temperature is from about −5° C. to about 5° C. In one embodiment, the initial temperature is at least 10 degrees lower than the final temperature and the temperature is adjusted to increase the reaction rate as the solution become more concentrated. In a still further embodiment, the temperature may be lowered, raised, and lowered in any combination, especially when forming multiple block co-polymers and the reactivity of one or more of the reagents is thermodynamically or kinetically lower or higher than the previous reaction.

Step (e)

Step (e) is a final step that includes removal of protecting groups from an amino acid or relates to a final purification step. Step (e) can involve both the isolation of the desired polymer and the removal of one or more protecting groups at the same time. Some isolation steps can be conducted in a manner that does not remove protecting groups, or alternatively the isolation step can be conducted in a manner that selectively removes one type of protecting group. The isolation step can include evaporation, isolation or a precipitate, or a combination thereof. Other optional final steps, or intermediate steps can be added to the disclosed process.

The following are non-limiting examples of procedures for preparing amino acid comprising polymers.

### EXAMPLE 1

### Comparative

(Polyethylene glycol MW 5000)-b-poly(TFA-L-lysine) was prepared using the prior art process by ring opening polymerization of N-[4-(2,5-dioxooxazolidin-4-yl)butyl]-2,2,2-trifluoracetamide (Lys NCA). The polymerization was initiated by α-methoxy-ω-aminoPEG, M_{w}=5,000 Da. DMF was distilled on a 4 Å molecular sieve under vacuum before the polymerization. In a Schlenk flask fitted with a stir bar and a silicon septum, 1.34 g of Lys NCA was dissolved under argon with (50-X) mL of DMF. The amount of α-methoxy-ω-amino PEG, that corresponded to the desired molar ratio of monomer to initiator (M/I), was dissolved under argon with X mL DMF to obtain a 65 g/L α-methoxy-ω-aminoPEG solution. This solution was then added to the Lys NCA solution and the reaction mixture was stirred at room temperature. After 48 h, the solvent was evaporated under vacuum at 100° C. and a solid was obtained. The crude product was washed with 100 mL of dry THF and filtrated. The filtrate was concentrated under vacuum, poured into 20-fold excess of Et₂O and filtered to give a white solid. The precipitated polymer was then lyophilized from a MeOH/benzene mixture to obtain a white powder. All the yields were around 90-95% depending the M/I ratio. The product thus obtained produced a broad multimodal molecular weight distribution as indicated by the dashed line in FIG. 1.

### EXAMPLE 2

(Polyethylene glycol MW 5000)-b-poly(ω-TFA-L-lysine) was prepared according to the disclosed process by ring opening polymerization of N-[4-(2,5-dioxooxazolidin-4-yl)butyl]-2,2,2-trifluoracetamide (Lys NCA). (Polyethylene glycol MW 5000)-b-poly(TFA-L-lysine) was synthesized by ring opening polymerization of Lys NCA in DMF. The polymerization was initiated by α-methoxy-ω-aminoPEG. DMF was distilled on a 4 Å molecular sieve under vacuum before the polymerization. In a Schlenk flask fitted with a stir bar and a silicon septum, 1.34 g of Lys NCA was dissolved under argon with (50-X) mL of DMF containing 1 M dry thiourea. The Schlenk flask was then cooled to 0° C. The amount of α-methoxy-ω-amino-PEG that corresponded to the desired molar ratio of monomer to initiator (M/I) was dissolved under argon with X mL of 1 M thiourea DMF to obtain a 65 g/L α-methoxy-ω-aminoPEG solution. This solution was then added to the Lys NCA solution and the reaction mixture was stirred at 0° C. After 4 weeks, the solvent was evaporated under vacuum at 100° C. until obtaining a solid. The crude product was washed with 100 mL of dry THF and filtrated. The filtrate was concentrated under vacuum, poured into 20-fold excess of Et₂O and filtered to give a white solid. The precipitated polymer was then lyophilized from a MeOH/benzene mixture to obtain a white powder. All the yields were around 90-95% depending the M/I ratio. The product thus obtained produced a narrow molecular weight distribution as indicated by the solid line in FIG. 1.

### EXAMPLE 3

(Polyethylene glycol MW 5000)-b-poly(ω-benzyl-L-glutamate) was prepared according to the disclosed process by ring opening polymerization of benzyl 3-(2,5-dioxo-oxazolidin-4-yl)propanoate (Glu NCA). In a Schlenk flask fitted with a stir bar and a silicon septum, 1.315 g of Glu NCA was dissolved under argon with (50-X) mL of DMF containing 1 M dry thiourea. The Schlenk flask was then cooled to 0° C. The amount of α-methoxy-ω-aminoPEG that corresponded to the desired molar ratio of monomer to initiator (M/I) was dissolved under argon with X mL of 1 M thiourea DMF to obtain a 65 g/L α-methoxy-ω-amino-PEG solution. This solution was then added to the Glu NCA solution and the reaction mixture was stirred at 0° C. After 4 weeks, the solvent was evaporated under vacuum at 100° C. until obtaining a solid. The crude product was washed with 100 mL of dry THF and filtrated. The filtrate was concentrated under vacuum, poured into 20-fold excess of Et₂O and filtered to give a white solid. The precipitated polymer was then lyophilized from benzene to obtain a white powder. All the yields were around 90-95% depending the M/I ratio.

### EXAMPLE 4

(Polyethylene glycol MW 5000)-b-poly(ω-benzyl-L-aspartate) was prepared according to the disclosed process by ring opening polymerization of benzyl 2-(2,5-dioxooxazolidin-4-yl)acetate (Asp NCA). In a Schlenk flask fitted with a stir bar and a silicon septum, 1.315 g of Asp NCA was dissolved under argon with (50-X) mL of DMF containing 1 M dry thiourea. The Schlenk flask was then cooled to 0° C. The amount of α-methoxy-ω-aminoPEG that corresponded to the desired molar ratio of monomer to initiator (M/I) was dissolved under argon with X mL of 1 M thiourea DMF to obtain a 65 g/L α-methoxy-ω-aminoPEG solution. This solution was then added to the Asp NCA solution and the reaction mixture was stirred at 0° C. After 4 weeks, the solvent was evaporated under vacuum at 100° C. until obtaining a solid. The crude product was washed with 100 mL of dry THF and filtrated. The filtrate was concentrated under vacuum, poured into 20-fold excess of Et₂O and filtered to give a white solid. The precipitated polymer was then lyophilized from benzene to obtain a white powder. All the yields were around 90-95% depending the M/I ratio.

### EXAMPLE 5

Poly(N^{ε}-trifluoroacetyl-L-lysine) (PTLL) was synthesized by ring opening polymerization of Lys NCA in DMF. The polymerization was initiated by n-hexylamine. DMF was distilled on a 4 Å molecular sieve under vacuum and n-hexylamine was distilled from KOH under N₂ before the polymerization. In a Schlenk flask fitted with a stir bar and a silicon septum, 2.144 g of Lys NCA was dissolved under argon in 50 mL of distilled DMF containing 1 M thiourea and the reaction mixture was cooled before the addition of the initiator at 0° C. Then, a volume of n-hexylamine corresponding to a molar ratio of monomer to initiator (M/I) desired was added and the reaction mixture was stirred at 0° C. After 4 weeks, the crude reaction was concentrated under vacuum and poured into 20-fold excess of a 0.5 M NaCl aqueous solution. After filtration, the precipitated polymer was dried under vacuum to give a white powder. All the yields were around 90-95% depending the M/I ratio.

### EXAMPLE 6

(Polyethylene glycol MW 5000)-b-poly(ω-TFA-L-lysine) was prepared according to the disclosed process by ring opening polymerization of N-[4-(2,5-dioxooxazolidin-4-yl)butyl]-2,2,2-trifluoracetamide (Lys NCA). (Polyethylene glycol MW 5000)-b-poly(TFA-L-lysine) was synthesized by ring opening polymerization of Lys NCA in DMF. The polymerization was initiated by α-methoxy-ω-aminoPEG. DMF was distilled on a 4 Å molecular sieve under vacuum before the polymerization. In a Schlenk flask fitted with a stir bar and a silicon septum, 1.34 g of Lys NCA was dissolved under argon with (50-X) mL of DMF containing 1 M dry thiourea. The Schlenk flask was then cooled to 0° C. The amount of α-methoxy-ω-amino-PEG that corresponded to the desired molar ratio of monomer to initiator (M/I) was dissolved under argon with X mL of 1 M thiourea DMF to obtain a 65 g/L α-methoxy-ω-aminoPEG solution. This solution was then added to the Lys NCA solution and the reaction mixture was stirred at 0° C. After 4 weeks, leucine NCA dissolved in X mL of DMF containing 1 M dry thiourea is added. The Schlenk flask was then cooled to 0° C. and allowed to stir. After 2 to 4 weeks, the solvent was removed under vacuum and the crude product was washed with 100 mL of dry THF and filtrated. The filtrate was concentrated under vacuum, poured into 20-fold excess of Et₂O and filtered to give a white solid. The precipitated polymer was then lyophilized from a MeOH/benzene mixture to obtain a white powder. All the yields were around 90-95% depending the M/I ratio.

It has been found that many of the final, de-protected polymers prepared by the disclosed process form gels in water at concentrations at or below 1% by weight. The formulator can utilize the properties of amino acids obtained by the present process to form hydrogels, vesicles, and micelles. In addition, the mono dispersed amino acid comprising polymers can hold a positive charge and are therefore useful as carriers for gene delivery or, alternatively, the polymers can be modified to provide antibacterial activity. Because the processes disclosed herein do not utilize heavy metals, the formation of poly thiol comprising polymers can be achieved. These polymers can be used to form biosensors, as well as biodegradable and/or biocompatible surface coatings.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A polymer having the formula: 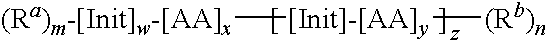
wherein each AA is:
a) a homopolymer comprising a protected or unprotected amino acid; or
b) a copolymer comprising one or more protected or unprotected amino acids;
Init is a residue that derives from an initiator;
R^{a} and R^{b} are each independently:
i) hydrogen;
ii) a protecting group; or
xiii) a reactive moiety capable of forming one or more bonds to a substrate;
the indices m and n are independently 0 or 1;
the index w is 0 or 1;
the index x is from about 10 to about 400;
the index y is from about 10 to about 400; and
the index z is form 0 to 5.

2. The polymer according to claim 1, having the formula:
[Init]-[AA]ₓ-(R^{b})ₙ
wherein AA is a homopolymer comprising an amino acid or a protected amino acid;
Init is chosen from:
i) H[O(CR^{1a}R^{1b})ₙ]ₘO—;
ii) H[O(CR^{1a}R^{1b})ₙ]ₘ[O(CR^{2a}R^{2b})ⱼ]ₖO—;
iii) R³(CR^{1a}R^{1b})ₙO—;
iv) R³(CR^{1a}R^{1b})ₙNH—;
v) R³(CR^{1a}R^{1b})ₙS—;
vi) R³[O(CR^{1a}R^{1b})ₙ]ₘO—;
vii) R³[O(CR^{1a}R^{1b})ₙ]ₘ[O(CR^{2a}R^{2b})ⱼ]ₖO—;
viii) H[O(CR^{1a}R^{1b})ₙ]ₘNH—;
ix) H[O(CR^{1a}R^{1b})ₙ]ₘ[O(CR^{2a}R^{2b})ⱼ]ₖNH—;
x) R³[O(CR^{1a}R^{1b})ₙ]ₘNH—;
xi) H₂NCR^{1a}R^{1b}[O(CR^{1a}R^{1b})ₙ]ₘNH—;
xii) R³[O(CR^{1a}R^{1b})ₙ]ₘ[O(CR^{2a}R^{2b})]NH—;
xiii) H[O(CR^{1a}R^{1b})]ₘS—;
xiv) H[O(CR^{1a}R^{1b})ₙ]ₘ[O(CR^{2a}R^{2b})ⱼ]ₖS—;
xv) HSCR^{1a}R^{1b}[O(CR^{1a}R^{1b})ₙ]ₘS—;
xvi) HSCR^{1a}R^{1b}[O(CR^{1a}R^{1b})ₙ]ₘ[O(CR^{2a}R^{2b})ⱼ]ₖS—;
xvii) R³[O(CR^{1a}R^{1b})ₙ]ₘS—; and
xviii) R³[O(CR^{1a}R^{1b})ₙ]ₘ[O(CR^{2a}R^{2b})ⱼ]ₖS—;
wherein each R^{1a} and R^{1b} is independently chosen from hydrogen and C₁-C₂ alkyl;
R^{2a} and R^{2b} is independently chosen from hydrogen and C₁-C₂ alkyl; R³ is C₁-C₄ linear alkyl; the index n is from 2 to 6, the index j is from 3 to 6, the indices m and k are each independently from 1 to 500; provided the index n and the index j are not the same; and
R^{b} is:
i) hydrogen;
ii) a protecting group; or
iii) a labile unit.

3. The polymer according to claim 2, wherein AA is an amino acid or a protected amino acid chosen from chosen from alanine, 2-aminohexanoic acid, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, 2-aminobutyric acid, 2-aminoisobutyric acid, 3-aminobutyric acid, 2-aminopentanoic acid, ornithine, citrulline, naphth-1-ylalanine, naphth-2-ylananine, phenylgylcine, homoserine, and lanthionine.

4. The polymer according to claim 2, wherein AA is a homopolymer comprising an amino acid or a protected amino acid chosen from:
i) lysine;
ii) ornithine;
iii) aspartic acid;
vi) glutamic acid;
vii) cysteine;
viii) asparagine;
ix) serine; or
x) threonine.

5. The polymer according to claim 2, wherein the amino terminal end of the amino acid homopolymer comprises a protecting group.

6. The polymer according to claim 2, wherein from about 10% to about 99% of the protected amino acids comprise a first protecting group and the balance have a second protecting group that is capable of being removed without removing the first protecting group.

7. The polymer according to claim 2, wherein from about 10% to about 90% of the protected amino acids comprise a first protecting group and the balance have a second protecting group that is capable of being removed without removing the first protecting group.

8. The polymer according to claim 2, wherein from about 10% to about 70% of the protected amino acids comprise a first protecting group and the balance have a second protecting group that is capable of being removed without removing the first protecting group.

9. The polymer according to claim 2, wherein from about 10% to about 50% of the protected amino acids comprise a first protecting group and the balance have a second protecting group that is capable of being removed without removing the first protecting group.

10. The polymer according to claim 2, wherein from about 10% to about 30% of the protected amino acids comprise a first protecting group and the balance have a second protecting group that is capable of being removed without removing the first protecting group.

11. The polymer according to claim 2, wherein R^{b} comprises a labile unit.

12. The polymer according to claim 2, wherein R^{b} comprises a labile unit that is a leaving group chosen from:
i) chloro;
ii) bromo;
iii) iodo;
iv) tosyl;
v) mesyl;
vi) azido; and
vii) cyano.

13. The polymer according to claim 2, wherein R^{b} comprises a labile unit that is chosen from:
i) isocyano;
ii) isothiocyano;
iii) carboxylate;
iv) carboxyamine; and
v) hydroxylamino.

14. The polymer according to claim 1, having the formula:
[Init]-[AA]ₓ-(R^{b})ₙ
wherein AA is a random copolymer comprising at least one protected amino acid;
Init is chosen from:
i) H[O(CR^{1a}R^{1b})ₙ]ₘO—;
ii) H[O(CR^{1a}R^{1b})ₙ]ₘ[O(CR^{2a}R^{2b})ⱼ]ₖO—;
iii) R³(CR^{1a}R^{1b})ₙO—;
iv) R³(CR^{1a}R^{1b})ₙNH—;
v) R³(CR^{1a}R^{1b})ₙS—;
vi) R³[O(CR^{1a}R^{1b})ₙ]ₘO—;
vii) R³[O(CR^{1a}R^{1b})ₙ]ₘ[O(CR^{2a}R^{2b})ⱼ]ₖO—;
viii) H[O(CR^{1a}R^{1b})ₙ]ₘNH—;
ix) H[O(CR^{1a}R^{1b})ₙ]ₘ[O(CR^{2a}R^{2b})ⱼ]ₖNH—;
x) R³[O(CR^{1a}R^{1b})ₙ]ₘNH—;
xi) H₂NCR^{1a}R^{1b}[O(CR^{1a}R^{1b})ₙ]ₘNH—;
xii) R³[O(CR^{1a}R^{1b})ₙ]ₘ[O(CR^{2a}R^{2b})ⱼ]ₖNH—;
xiii) H[O(CR^{1a}R^{1b})ₙ]ₘS—;
xiv) H[O(CR^{1a}R^{1b})ₙ]ₘ[O(CR^{2a}R^{2b})ⱼ]ₖS—;
xv) HSCR^{1a}R^{1b}[O(CR^{1a}R^{1b})ₙ]ₘS—;
xvi) HSCR^{1a}R^{1b}[O(CR^{1a}R^{1b})ₙ]ₘ[O(CR^{2a}R^{2b})ⱼ]ₖS—;
xvii) R³[O(CR^{1a}R^{1b})ₙ]ₘS—; and
xviii) R³[O(CR^{1a}R^{1b})ₙ]ₘ[O(CR^{2a}R^{2b})ⱼ]ₖS—;
wherein each R^{1a} and R^{1b} is independently chosen from hydrogen and C₁-C₂ alkyl;
R^{2a} and R^{2b} is independently chosen from hydrogen and C₁-C₂ alkyl; R³ is C₁-C₄ linear alkyl; the index n is from 2 to 6, the index j is from 3 to 6, the indices m and k are each independently from 1 to 500; provided the index n and the index j are not the same; and
R^{b} is:
i) hydrogen;
ii) a protecting group; or
iii) a labile unit.

15. The polymer according to claim 14, wherein AA is an amino acid or a protected amino acid chosen from chosen from alanine, 2-aminohexanoic acid, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, 2-aminobutyric acid, 2-aminoisobutyric acid, 3-aminobutyric acid, 2-aminopentanoic acid, ornithine, citrulline, naphth-1-ylalanine, naphth-2-ylananine, phenylgylcine, homoserine, and lanthionine.

16. The polymer according to claim 14, wherein AA is a random copolymer comprising an amino acid or a protected amino acid chosen from:
i) lysine;
ii) ornithine;
iii) aspartic acid;
iv) glutamic acid;
v) cysteine;
vi) arginine;
vii) serine; or
viii) threonine.

17. The polymer according to claim 14, wherein the amino terminal end of the random copolymer comprises a protecting group.

18. The polymer according to claim 14, wherein from about 10% to about 99% of the amino acids comprising the random copolymer are protected amino acids.

19. The polymer according to claim 14, wherein from about 10% to about 90% of the amino acids comprising the random copolymer are protected amino acids.

20. The polymer according to claim 14, wherein from about 10% to about 70% of the amino acids comprising the random copolymer are protected amino acids.

21. The polymer according to claim 14, wherein from about 10% to about 50% of the amino acids comprising the random copolymer are protected amino acids.

22. The polymer according to claim 14, wherein from about 10% to about 30% of the amino acids comprising the random copolymer are protected amino acids.

23. The polymer according to claim 14, wherein R^{b} comprises a labile unit.

24. The polymer according to claim 14, wherein R^{b} comprises a labile unit that is a leaving group chosen from:
i) chloro;
ii) bromo;
iii) iodo;
iv) tosyl;
v) mesyl;
vi) azido;
vii) cyano;
viii) isocyano;
ix) isothiocyano;
x) carboxylate;
xi) carboxyamine; and
xii) hydroxylamino

25. The polymer according to claim 1, having the formula:
[Init]-[AA]ₓ-(R^{b})ₙ
wherein AA is a block copolymer having the formula:
[AA₁]ₓ_{¹}-[AA₁]ₓ_{²}
AA₁ represents a block polymer of a first protected or unprotected amino acid;
AA₂ represents a block polymer of a second protected or unprotected amino acid;
the indices x¹+x²=x; the index x is from about 10 to about 400;
Init is chosen from:
i) H[O(CR^{1a}R^{1b})ₙ]ₘO—;
ii) H[O(CR^{1a}R^{1b})ₙ]ₘ[O(CR^{2a}R^{2b})ⱼ]ₖO—;
iii) R³(CR^{1a}R^{1b})ₙO—;
iv) R³(CR^{1a}R^{1b})ₙNH—;
v) R³(CR^{1a}R^{1b})ₙS—;
vi) R³[O(CR^{1a}R^{1b})ₙ]ₘO—;
vii) R³[O(CR^{1a}R^{1b})ₙ]ₘ[O(CR^{2a}R^{2b})ⱼ]ₖO—;
viii) H[O(CR^{1a}R^{1b})ₙ]ₘNH—;
ix) H[O(CR^{1a}R^{1b})ₙ]ₘ[O(CR^{2a}R^{2b})ⱼ]ₖNH—;
x) R³[O(CR^{1a}R^{1b})ₙ]ₘNH—;
xi) H₂NCR^{1a}R^{1b}[O(CR^{1a}R^{1b})ₙ]ₘNH—;
xii) R³[O(CR^{1a}R^{1b})ₙ]ₘ[O(CR^{2a}R^{2b})ⱼ]ₖNH—;
xiii) H[O(CR^{1a}R^{1b})ₙ]ₘS—;
xiv) H[O(CR^{1a}R^{1b})ₙ]ₘ[O(CR^{2a}R^{2b})ⱼ]ₖS—;
xv) HSCR^{1a}R^{1b}[O(CR^{1a}R^{1b})ₙ]ₘS—;
xvi) HSCR^{1a}R^{1b}[O(CR^{1a}R^{1b})ₙ]ₘ[O(CR^{2a}R^{2b})ⱼ]ₖS—;
xvii) R³[O(CR^{1a}R^{1b})ₙ]ₘS—; and
xviii) R³[O(CR^{1a}R^{1b})ₙ]ₘ[O(CR^{2a}R^{2b})ⱼ]ₖS—;
wherein each R^{1a} and R^{1b} is independently chosen from hydrogen and C₁-C₂ alkyl;
R^{2a} and R^{2b} is independently chosen from hydrogen and C₁-C₂ alkyl; R³ is C₁-C₄ linear alkyl; the index n is from 2 to 6, the index j is from 3 to 6, the indices m and k are each independently from 1 to 500; provided the index n and the index j are not the same; and
R^{b} is:
i) hydrogen;
ii) a protecting group; or
ii) a labile unit.

26. The polymer according to claim 25, wherein AA is an amino acid or a protected amino acid chosen from chosen from alanine, 2-aminohexanoic acid, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, 2-aminobutyric acid, 2-aminoisobutyric acid, 3-aminobutyric acid, 2-aminopentanoic acid, ornithine, citrulline, naphth-1-ylalanine, naphth-2-ylananine, phenylgylcine, homoserine, and lanthionine.

27. The polymer according to claim 25, wherein AA₁ is a block polymer of an amino acid chosen from:
i) lysine;
ii) ornithine;
iii) aspartic acid;
iv) glutamic acid;
v) cysteine;
vi) arginine;
vii) serine; or
viii) threonine.

28. The polymer according to claim 25, wherein AA₁ is a block polymer of a protected amino acid chosen from:
i) lysine;
ii) ornithine;
iii) aspartic acid;
iv) glutamic acid;
v) cysteine;
vi) arginine;
vii) serine; or
viii) threonine.

29. The polymer according to claim 25, wherein AA₂ is a block polymer of a protected or unprotected amino acid chosen from:
i) lysine;
ii) ornithine;
iii) aspartic acid;
iv) glutamic acid;
v) cysteine;
vi) asparagine;
vii) arginine;
viii) serine; or
ix) threonine.
provided the protected or unprotected amino acid that comprises AA₁ is not the same as the protected or unprotected amino acid that comprises AA₂.

30. The polymer according to claim 1, wherein Init has the formula:
R³[OCH₂CH₂]ₘO—
R³ is methyl or ethyl, the index m is from about 10 to about 500.

31. The polymer according to claim 1, wherein Init has the formula:
CH₃[OCH₂CH₂]ₘO—
the index m has a value such that Init is derived from a MPEG having an average molecular weight of from about 500 Da to about 20,000 Da.

32. The polymer according to claim 1, wherein Init is derived from a MPEG having an average molecular weight of from about 500 Da to about 10,000 Da.

33. The polymer according to claim 1, wherein Init is derived from a MPEG having an average molecular weight of from about 3,000 Da to about 7,000 Da.

34. The polymer according to claim 1, wherein Init has the formula:
R³[OCH₂CH₂]ₘNH—
R³ is methyl or ethyl, the index m is from about 10 to about 500.

35. The polymer according to claim 1, wherein Init has the formula:
CH₃[OCH₂CH₂]ₘNH—
the index m has a value such that Init is derived from a MPEG amine having an average molecular weight of from about 500 Da to about 20,000 Da.

36. The polymer according to claim 1, wherein Init is derived from a MPEG amine having an average molecular weight of from about 500 Da to about 10,000 Da.

37. The polymer according to claim 1, wherein Init is derived from a MPEG amine having an average molecular weight of from about 3,000 Da to about 7,000 Da.

38. The polymer according to claim 1, wherein Init has the formula:
R³[OCH₂CH₂]ₘS—
R³ is methyl or ethyl, the index m is from about 10 to about 500.

39. The polymer according to claim 1, wherein Init has the formula:
CH₃[CH₂]ₘNH—
m is from about 1 to about 20.

40. The polymer according to claim 1, wherein Init is derived from an amine chosen from methylamine, ethylamine, propylamine, butylamine, pentylamine, hexylamine, heptylamine, and octylamine.

41. The polymer according to claim 1, wherein Init is derived from hexylamine.

42. The polymer according to claim 1, wherein Init has the formula:
CH₃[CH₂]ₘS—
m is from about 1 to about 20.

43. The polymer according to claim 1, wherein Init has the formula:
CH₃[CH₂]ₘO—
m is from about 10 to about 20.

44. The polymer according to claim 1, wherein Init has the formula:
HO[CH₂]ₘS—
m is from about 2 to about 20.

45. The polymer according to claim 1, wherein Init is derived from ethane thiol.

46. The polymer according to claim 1, having the formula:
(R^{a})ₘ-[AA]ₓ-[Init]-[AA]_{y}-(R^{b})ₙ
wherein each AA is a homopolymer of a protected or unprotected amino acid, and each AA can comprise the same or a different protected or unprotected amino acid;
Init is chosen from:
i) —[O(CR^{1a}R^{1b})ₙ]ₘO—;
ii) —[O(CR^{1a}R^{1b})ₙ]ₘ[O(CR^{2a}R^{2b})ⱼ]ₖO—;
viii) —[O(CR^{1a}R^{1b})ₙ]ₘNH—;
ix) —[O(CR^{1a}R^{1b})ₙ]ₘ[O(CR^{2a}R^{2b})ⱼ]ₖNH—;
x) —HNCR^{1a}R^{1b}[O(CR^{1a}R^{1b})ₙ]ₘNH—;
xiii) —[O(CR^{1a}R^{1b})ₙ]ₘS—;
xiv) —[O(CR^{1a}R^{1b})ₙ]ₘ[O(CR^{2a}R^{2b})ⱼ]ₖS—;
xv) —SCR^{1a}R^{1b}[O(CR^{1a}R^{1b})ₙ]ₘS—; and
xvi) —SCR^{1a}R^{1b}[O(CR^{1a}R^{1b})]ₘ[O(CR^{2a}R^{2b})ⱼ]ₖS—;
wherein each R^{1a} and R^{1b} is independently chosen from hydrogen and C₁-C₂ alkyl;
R^{2a} and R^{2b} is independently chosen from hydrogen and C₁-C₂ alkyl; R³ is C₁-C₄ linear alkyl; the index n is from 2 to 6, the index j is from 3 to 6, the indices m and k are each independently from 1 to 500; provided the index n and the index j are not the same; and
R^{a} and R^{b} are each independently:
i) hydrogen;
ii) a protecting group; or
iii) a labile unit.

47. The polymer according to claim 46, wherein one AA is an amino acid or a protected amino acid chosen from chosen from alanine, 2-aminohexanoic acid, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, 2-aminobutyric acid, 2-aminoisobutyric acid, 3 aminobutyric acid, 2-aminopentanoic acid, ornithine, citrulline, naphth-1-ylalanine, naphth-2-ylananine, phenylgylcine, homoserine, and lanthionine.

48. The polymer according to claim 46, wherein one AA is a homopolymer comprising an amino acid or protected amino acid chosen from:
i) lysine;
ii) ornithine;
iii) aspartic acid;
iv) glutamic acid;
v) cysteine;
vi) arginine;
vii) serine; or
viii) threonine

49. The polymer according to claim 46, wherein Init has the formula:
—[OCH₂CH₂]ₘO—
the index m is from about 10 to about 500.

50. The polymer according to claim 46, wherein Init has the formula:
—[OCH₂CH₂]ₘO—
the index m has a value such that Init is derived from a PEG having an average molecular weight of from about 500 Da to about 20,000 Da.

51. The polymer according to claim 46, wherein Init is derived from a PEG having an average molecular weight of from about 500 Da to about 10,000 Da.

52. The polymer according to claim 46, wherein Init is derived from a PEG having an average molecular weight of from about 3,000 Da to about 7,000 Da.

53. The polymer according to claim 46, wherein Init has the formula:
—[OCH₂CH₂]ₘNH—
the index m is from about 10 to about 500.

54. The polymer according to claim 46, wherein Init has the formula:
[OCH₂CH₂]ₘNH—
the index m has a value such that Init is derived from a PEG amine having an average molecular weight of from about 500 Da to about 20,000 Da.

55. The polymer according to claim 46, wherein Init is derived from a PEG amine having an average molecular weight of from about 500 Da to about 10,000 Da.

56. The polymer according to claim 46, wherein Init is derived from a PEG amine having an average molecular weight of from about 3,000 Da to about 7,000 Da.

57. The polymer according to claim 46, wherein Init has the formula:
—[OCH₂CH₂]ₘS—
R³ is methyl or ethyl, the index m is from about 50 to about 500.

58. The polymer according to claim 46, wherein Init has the formula:
—[CH₂]ₘNH—
m is from about 1 to about 20.

59. The polymer according to claim 2, wherein Init has the formula:
—[CH₂]ₘS—
m is from about 2 to about 20.

60. The polymer according to claim 2, wherein Init has the formula:
—[CH₂]ₘO—
m is from about 2 to about 20.

61. The polymer according to claim 2, wherein Init has the formula:
—O[CH₂]ₘS—
m is from about 2 to about 20.

62. The polymer according to claim 2, wherein Init is derived from ethane thiol.

63. A polymer formed by the process, comprising:
a) providing a source of one or more amino acid N-carboxyanhydrides, protected amino acid N-carboxyanhydrides, or mixtures thereof;
b) combining the source from step (a) with a hydrogen bond inhibitor to form an admixture;
c) combining the admixture from step (b) with an initiator; and
d) forming an amino acid polymer.

64. The polymer according to claim 63, wherein step (a) further comprises one or more solvents.

65. The polymer according to claim 63, wherein the hydrogen bond inhibitor is chosen from thiourea, urea, guanidine, a primary amine, or a salt thereof.

66. The polymer according to claim 63, wherein the initiator is a diamine having the formula:
H₂N(CR^{4a}R^{4b})ᵣNH₂
wherein R^{4a} and R^{4b} are each independently hydrogen or C₁-C₄ alkyl, and the index r is from 2 to about 20.

67. The polymer according to claim 63, wherein the initiator is a polyalkyleneoxy amine chosen from:
i) H[O(CR^{1a}R^{1b})ₙ]ₘNH₂;
ii) H[O(CR^{1a}R^{1b})ₙ]ₘ[O(CR^{2a}R^{2b})ⱼ]ₖNH₂;
iii) R³[O(CR^{1a}R^{1b})ₙ]ₘNH₂;
iv) H₂NCR^{1a}R^{1b}[O(CR^{1a}R^{1b})ₙ]ₘNH₂; and
v) R³[O(CR^{1a}R^{1b})ₙ]ₘ[O(CR^{2a}R^{2b})ⱼ]ₖNH₂;
wherein each R^{1a} and R^{1b} is independently chosen from hydrogen and C₁-C₂ alkyl;
R^{2a} and R^{2b} is independently chosen from hydrogen and C₁-C₂ alkyl; R³ is C₁-C₄ linear alkyl; the index n is from 2 to 6, the index j is from 3 to 6, the indices m and k are each independently from 1 to 500; provided the index n and the index j are not the same.

68. The polymer according to claim 63, wherein the initiator is a polyethylene glycol chosen from:
i) H[O(CR^{1a}R^{1b})ₙ]ₘOH;
ii) H[O(CR^{1a}R^{1b})ₙ]ₘ[O(CR^{2a}R^{2b})ⱼ]ₖOH;
iii) R³[O(CR^{1a}R^{1b})ₙ]ₘOH; and
iv) R³[O(CR^{1a}R^{1b})ₙ]ₘ[O(CR^{2a}R^{2b})ⱼ]ₖOH;
wherein each R^{1a} and R^{1b} is independently chosen from hydrogen and C₁-C₂ alkyl;
R^{2a} and R^{2b} is independently chosen from hydrogen and C₁-C₂ alkyl; R³ is C₁-C₄ linear alkyl; the index n is from 2 to 6, the index j is from 3 to 6, the indices m and k are each independently from 1 to 500; provided the index n and the index j are not the same.

69. The polymer according to claim 63, wherein the initiator is a polyalkyleneoxy thiol chosen from:
i) H[O(CR^{1a}R^{1b})ₙ]ₘSH;
ii) H[O(CR^{1a}R^{1b})ₙ]ₘ[O(CR^{1a}R^{1b})ⱼ]ₖSH;
iii) HSCR^{1a}R^{1b}[O(CR^{1a}R^{1b})ₙ]ₘSH;
iv) HSCR^{1a}R^{1b}[O(CR^{1a}R^{1b})ₙ]ₘ[O(CR^{2a}R^{2b})ⱼ]ₖSH;
v) R³[O(CR^{1a}R^{1b})ₙ]ₘSH; and
vi) R³[O(CR^{1a}R^{1b})ₙ]ₘ[O(CR^{2a}R^{2b})ⱼ]ₖSH;
wherein each R^{1a} and R^{1b} is independently chosen from hydrogen and C₁-C₂ alkyl;
R^{2a} and R^{2b} is independently chosen from hydrogen and C₁-C₂ alkyl; R³ is C₁-C₄ linear alkyl; the index n is from 2 to 6, the index j is from 3 to 6, the indices m and k are each independently from 1 to 500; provided the index n and the index j are not the same.

70. The polymer according to claim 63, wherein the initiator is a multi-arm unit having the formula:
i) C[CH₂[O(CR^{3a}R^{3b})ₚ]_{q}OH]₄;
ii) C[CH₂[O(CR^{3a}R^{3b})ₚ]_{q}NH₂]₄; and
iii) C[CH₂[O(CR^{3a}R^{3b})ₚ]_{q}SH]₄;
wherein each R^{3a} and R^{3b} is independently chosen from hydrogen and C₁-C₂ alkyl; the index p is from 2 to 6, the index q is from 1 to 500.

71. The polymer according to claim 67, wherein the initiator is an amino acid chosen from alanine, arginine, asparagines, aspartic acid, cysteine, glutamic acid, glutamine, histidine, isoleucine, leucine, lysine, methionine, phenylalanine, proline, serine, threonine, tryptophan, tyrosine, valine, 2-aminobutyric acid, 2-aminoisobutyric acid, 3-aminobutyric acid, 2-aminopentanoic acid, ornithine, citrulline, naphth-1-ylalanine, naphth-2-ylananine, phenylgylcine, homoserine, and lanthionine of a protected amino acid protected with one or more protecting groups chosen from methyl, formyl, ethyl, acetyl, tert-butyl, anisyl, benzyl, trifluoroacetyl, N-hydroxysuccinimide, tert-butoxy-carbonyl, methoxycarbonyl, benzoyl-4-methylbenzyl, thioanizyl, thiocresyl, benzyloxymethyl, 4-nitrophenyl, benzyloxycarbonyl, 2-nitrobenzoyl, 2-nitro-phenylsulphenyl, 4-toluenesulphonyl, pentafluorophenyl, diphenylmethyl, 2-chlorobenzyloxycarbonyl, 9-fluorenylmethyloxycarbonyl, triphenylmethyl, and 2,2,5,7,8-pentamethyl-chroman-6-sulphonyl.

72. The polymer according to claim 63, wherein the initiator is an amine comprising polymer.

73. The polymer according to claim 63, wherein the amino acid provided in step (a) is chosen from alanine, arginine, asparagines, aspartic acid, cysteine, glutamic acid, glutamine, histidine, isoleucine, leucine, lysine, methionine, phenylalanine, proline, serine, threonine, tryptophan, tyrosine, valine, 2-aminobutyric acid, 2-aminoisobutyric acid, 3-aminobutyric acid, 2-aminopentanoic acid, ornithine, citrulline, naphth-1-ylalanine, naphth-2-ylananine, phenylgylcine, homoserine, and lanthionine.

74. The polymer according to claim 63, wherein the amino acid provided in step (a) is protected with one or more protecting groups chosen from methyl, formyl, ethyl, acetyl, tert-butyl, anisyl, benzyl, trifluoroacetyl, N-hydroxysuccinimide, tert-butoxycarbonyl, methoxycarbonyl, benzoyl-4-methylbenzyl, thioanizyl, thiocresyl, benzyloxymethyl, 4-nitrophenyl, benzyloxycarbonyl, 2-nitrobenzoyl, 2-nitrophenylsulphenyl, 4-toluenesulphonyl, pentafluorophenyl, diphenylmethyl, 2-chlorobenzyloxycarbonyl, 9-fluorenylmethyloxycarbonyl, triphenylmethyl, and 2,2,5,7,8-pentamethyl-chroman-6-sulphonyl.

75. The polymer according to claim 63, wherein the poly(amino acid) has a polydispersity of from greater than 1 to about 1.5.

76. The polymer according to claim 63, wherein the process is conducted at a temperature of from about −30° C. to about 30° C.

77. The polymer according to claim 63, wherein the polymer comprises from about 10 to about 400 amino acid residues.

78. The polymer according to claim 63, wherein the polymer has an average molecular weight of from about 500 Daltons to about 150,000 Daltons.

79. The polymer according to claim 63, wherein the process further comprises the step of removing one or more protecting groups that are present.

80. A polymer having the formula: 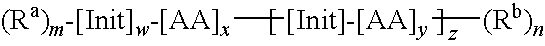
wherein each AA is:
a) a homopolymer comprising a protected or unprotected amino acid; or
b) a copolymer comprising one or more protected or unprotected amino acids;
Init is a residue that derives from an initiator;
R^{a} and R^{b} are each independently:
i) hydrogen; or
ii) a protecting group;
the indices m and n are independently 0 or 1;
the index w is 0 or 1;
the index x is from about 10 to about 400;
the index y is from about 10 to about 400; and
the index z is form 0 to 5;
the polymer formed by the process, comprising:
a) providing a source of one or more amino acid N-carboxyanhydrides, protected amino acid N-carboxyanhydrides, or mixtures thereof;
b) combining the source from step (a) with a hydrogen bond inhibitor to form an admixture;
c) combining the admixture from step (b) with an initiator; and
d) forming an amino acid polymer.

81. A polymer according to claim 80, having the formula:
[Init]-[AA]ₓ-R^{b}
wherein AA is a homopolymer or a random copolymer comprising an amino acid or a protected amino acid;
Init is a residue that derives from an initiator;
R^{b} is:
i) hydrogen; or
ii) a protecting group; and
the index x is from about 10 to about 400;
the polymer formed by the process, comprising:
a) providing a source of one or more amino acid N-carboxyanhydrides, or protected amino acid N-carboxyanhydrides;
b) combining the source from step (a) with a hydrogen bond inhibitor to form an admixture;
c) combining the admixture from step (b) with an initiator; and
d) forming an amino acid polymer.

82. The polymer according to claim 1, wherein the polymer is essentially free of any heavy metal catalyst.

83. A process for preparing polymers of amino acids, comprising:
a) providing a source of one or more amino acid N-carboxyanhydrides, protected amino acid N-carboxyanhydrides, or mixtures thereof in a solvent;
b) combining the source from step (a) with a hydrogen bond inhibitor chosen from thiorurea, urea, or guanidine, or a salt thereof, to form an admixture;
c) combining the admixture from step (b) with an initiator chosen from a primary amine or a polyalkylene glycol amine; and
d) forming an amino acid polymer.

84. A process for preparing polymers of amino acids, comprising:
a) providing a source of one or more amino acid N-carboxyanhydrides, protected amino acid N-carboxyanhydrides, or mixtures thereof in a solvent;
b) combining the source from step (a) with a hydrogen bond inhibitor chosen from thiorurea, urea, or guanidine, or a salt thereof, to form an admixture;
c) combining the admixture from step (b) with an initiator chosen from a primary amine or a polyalkylene glycol amine;
d) forming an amino acid polymer; and
e) deprotecting any amino acids needing deprotection.

85. A process for preparing polymers of amino acids having the formula:
H-[AA-1]ₓ₁[AA-2]ₓ₂-H
wherein AA-1 represents a first amino acid, AA-2 represents a second amino acid, x1 represents the mole fraction of the first amino acid, x2 represents the mole fraction of the second amino acid, and x1+x2=1, comprising:
a) providing a source of one or more amino acid N-carboxyanhydrides, protected amino acid N-carboxyanhydrides, or mixtures thereof in a solvent;
b) combining the source from step (a) with a hydrogen bond inhibitor chosen from thiorurea, urea, or guanidine, or a salt thereof, to form an admixture;
c) combining the admixture from step (b) with an initiator chosen from a primary amine or a polyalkylene glycol amine; and
d) forming an amino acid polymer.

86. A process for preparing polymers of amino acids having the formula:
[R³(CR^{1a}R^{1b})ₙNH][AA₁]ₓ_{¹}[AA₂]ₓ_{²}-H or
H—[R³(OCR^{1a}R^{1b})ₙ]ₘNH][AA₁]ₓ_{¹}[AA₂]ₓ_{²}-H
wherein AA₁ represents a first amino acid, AA₂ represents a second amino acid;
each R^{1a} and R^{1b} is independently chosen from hydrogen and C₁-C₂ alkyl; R^{2a} and R^{2b} is independently chosen from hydrogen and C₁-C₂ alkyl; R³ is C₁-C₄ linear alkyl; the index n is an integer from 2 to 6, the index m is an integer from 1 to 1500;
x¹ represents the mole fraction of the first amino acid, x² represents the mole fraction of the second amino acid, x³ represents the mole fraction of the third amino acid, and x¹+x²+x³=x; and x is an integer from 10 to 400, comprising:
a) providing a source of one or more amino acid N-carboxyanhydrides, protected amino acid N-carboxyanhydrides, or mixtures thereof in a solvent;
b) combining the source from step (a) with a hydrogen bond inhibitor chosen from thiorurea, urea, or guanidine, or a salt thereof, to form an admixture;
c) combining the admixture from step (b) with an initiator chosen from a primary amine or a polyalkylene glycol amine; and
d) forming an amino acid polymer; and
e) deprotecting any amino acids needing deprotection.

87. A process for preparing polymers of amino acids having the formula:
H—[R³(OCR^{1a}R^{1b})ₙ]ₘNH][AA₁]ₓ_{¹}[AA₂]ₓ_{²}[AA₃]ₓ_{³}-H or
[R³(CR^{1a}R^{1b})ₙNH][AA₁]ₓ_{¹}[AA₂]ₓ_{²}[AA₃]ₓ_{³}-H
wherein AA₁ represents a first amino acid, AA₂ represents a second amino acid, AA₃ represents a third amino acid;
each R^{1a} and R^{1b} is independently chosen from hydrogen and C₁-C₂ alkyl; R^{2a} and
R^{2b} is independently chosen from hydrogen and C₁-C₂ alkyl; R³ is C₁-C₄ linear alkyl; the index n is an integer from 2 to 6, the index m is an integer from 1 to 1500;
x represents the mole fraction of the first amino acid, x² represents the mole fraction of the second amino acid, x³ represents the mole fraction of the third amino acid, and
x¹+x²+x³=x; and x is an integer from 10 to 400, comprising:
a) providing a source of one or more amino acid N-carboxyanhydrides, protected amino acid N-carboxyanhydrides, or mixtures thereof in a solvent;
b) combining the source from step (a) with a hydrogen bond inhibitor chosen from thiorurea, urea, or guanidine, or a salt thereof, to form an admixture;
c) combining the admixture from step (b) with an initiator chosen from a primary amine or a polyalkylene glycol amine; and
d) forming an amino acid polymer.

88. A process for preparing polymers of amino acids having the formula:
H—[PEGNH][AA₁]ₓ_{¹}[AA₂]ₓ_{²}-H
wherein PEGNH represent a polyethylene glycol amine having a molecular weight of from about 500 g/mol to about 150,000 g/mol, AA₁ represents a first amino acid,
AA₂ represents a second amino acid, x¹ represents the mole fraction of the first amino acid, x² represents the mole fraction of the second amino acid, comprising:
a) providing a source of one or more amino acid N-carboxyanhydrides, protected amino acid N-carboxyanhydrides, or mixtures thereof in a solvent;
b) combining the source from step (a) with a hydrogen bond inhibitor chosen from thiorurea, urea, or guanidine, or a salt thereof, to form an admixture;
c) combining the admixture from step (b) with an initiator, the initiator a hydroxyl group protected polyethylene glycol amine having a molecular weight of from about 500 g/mol to about 150,000 g/mol; and
d) forming an amino acid polymer.

89. A process for preparing grafted amino acid polymers, comprising:
a) providing a source of at least one protected amino acid N-carboxyanhydrides;
b) combining the source from step (a) with a hydrogen bond inhibitor to form an admixture;
c) combining the admixture from step (b) with an initiator;
d) forming an amino acid polymer;
e) deprotecting the amino acids that comprise the polymer; and
f) further reacting the polymer with a source of one or more amino acid N-carboxyanhydrides, protected amino acid N-carboxyanhydrides, or mixtures thereof.
